(19) United States
(12) Patent Application Publication
(10) Pub. No.: US 2013/0003520 A1
(43) Pub. Date: Jan. 3, 2013

(54) OBJECTIVE LENS DRIVING APPARATUS

(75) Inventors: Akira IIJIMA, Ota-shi (JP); Shunichi MORIMOTO, Ota-shi (JP)

(73) Assignee: SANYO ELECTRIC CO., LTD., Osaka (JP)

(21) Appl. No.: 13/537,909

(22) Filed: Jun. 29, 2012

(30) Foreign Application Priority Data
Jun. 29, 2011 (JP) 2011-145005
May 21, 2012 (JP) 2012-115789

(51) Int. Cl. G11B 7/1374

(52) U.S. Cl. 369/112.23; G9B/7.121

(57) ABSTRACT

An objective lens driving apparatus includes: an objective lens opposing a signal recording surface of an optical disc; a lens holder configured to hold the objective lens; and an actuator configured to displace the lens holder in a focusing direction or a tracking direction of the optical disc, the actuator including a coil attached to the lens holder, a magnet configured to generate a magnetic field effectively acting on the coil, and a yoke having the magnet fixed thereto, the yoke formed by bending a sheet of metal plate into a rectangular shape around an axis in the tracking direction, and the magnet fixed to the yoke with an adhesive.

### CROSS-REFERENCE TO RELATED APPLICATIONS

This application claims the benefit of priority to Japanese Patent Application Nos. 2011-145005 and 2012-115789, filed Jun. 29, 2011 and May 21, 2012, respectively, of which full contents are incorporated herein by reference.

### BACKGROUND OF THE INVENTION

1. Field of the Invention

The present invention relates to an objective lens driving apparatus.

2. Description of the Related Art

In general, an actuator is known for displacing a lens holder holding an objective lens. In the actuator, when passing a current through a coil configuring the actuator to drive the coil, a reaction force caused by a magnetic force is generated in a magnet. When such an event occurs, if a frame attached with the magnet has low strength, the reaction force applied to the magnet excites resonance of the frame, which may adversely affect the loop characteristics of an optical pickup unit, for example. For this reason, the frame is required to have as much strength as possible to increase natural resonance frequency.

The “actuator” means a driving apparatus that converts energy into a translational motion or a rotational motion, etc., for example, and is abbreviated as “ACT”, for example. The frame means a mounting, a framework, and a structure, for example. The optical pickup or optical pickup unit is abbreviated as “OPU”, for example.

As for a method of increasing the strength of the frame, it is often performed to bond separate sheet-metal parts configuring the actuator such as a cover and the frame, for example. When the actuator is configured in such a manner, it is required to perform bonding at a plurality of locations.

With respect to other driving units and optical pickup units, there is an objective lens driving apparatus in the optical pickup capable of realizing high-speed reading by limiting an increase in thickness thereof to the minimum so as to increase the structural resonance frequency, for example (see, e.g., Japanese Patent Laid-Open Publication No. 1999-66585).

### SUMMARY OF THE INVENTION

An objective lens driving apparatus according to an aspect of the present invention, includes: an objective lens opposing a signal recording surface of an optical disc; a lens holder configured to hold the objective lens; and an actuator configured to displace the lens holder in a focusing direction or a tracking direction of the optical disc, the actuator including a coil attached to the lens holder, a magnet configured to generate a magnetic field effectively acting on the coil, and a yoke having the magnet fixed thereto, the yoke formed by bending a sheet of metal plate into a rectangular shape around an axis in the tracking direction, and the magnet fixed to the yoke with an adhesive.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a perspective view illustrating a part of an objective lens driving apparatus according to a first embodiment of the present invention;

FIG. 2 is a side view illustrating a part of an objective lens driving apparatus according to a first embodiment of the present invention;

FIG. 3 is a perspective view illustrating a housing to which a first embodiment of the present invention is applied;

FIG. 4 is a perspective view illustrating an objective lens driving apparatus when viewed from the side where objective lenses are exposed in a first embodiment of the present invention;

FIG. 5 is a perspective view illustrating an objective lens driving apparatus when viewed from the side to which foot plates extend in a first embodiment of the present invention;

FIG. 6 is a perspective view illustrating a yoke when viewed from the side to which a fifth bent portion and a sixth bent portion extend in a first embodiment of the present invention;

FIG. 7 is a perspective view illustrating a yoke when viewed from the side opposite to the side to which a fifth bent portion and a sixth bent portion extend in a first embodiment of the present invention;

FIG. 8 is a perspective view illustrating a housing, to which a first embodiment of the present invention is applied, when viewed from the side opposite to the side opposing an optical disc;

FIG. 9 is a perspective view illustrating an objective lens driving apparatus when viewed from the side where objective lenses are exposed in a second embodiment of the present invention;

FIG. 10 is a perspective view illustrating an objective lens driving apparatus when viewed from the side to which foot plates extend in a second embodiment of the present invention;

FIG. 11 is a perspective view illustrating a yoke when viewed from the side to which a sixth bent portion and a seventh bent portion extend in a second embodiment of the present invention;

FIG. 12 is a perspective view illustrating a yoke when viewed from the side opposite to the side to which a sixth bent portion and a seventh bent portion extend in a second embodiment of the present invention;

FIG. 13 is a perspective view illustrating a part of an objective lens driving apparatus according to a third embodiment of the present invention; and

FIG. 14 is a side view illustrating a part of an objective lens driving apparatus according to a third embodiment of the present invention.

### DETAILED DESCRIPTION OF THE INVENTION

At least the following details will become apparent from descriptions of this specification and of the accompanying drawings.

### First Embodiment

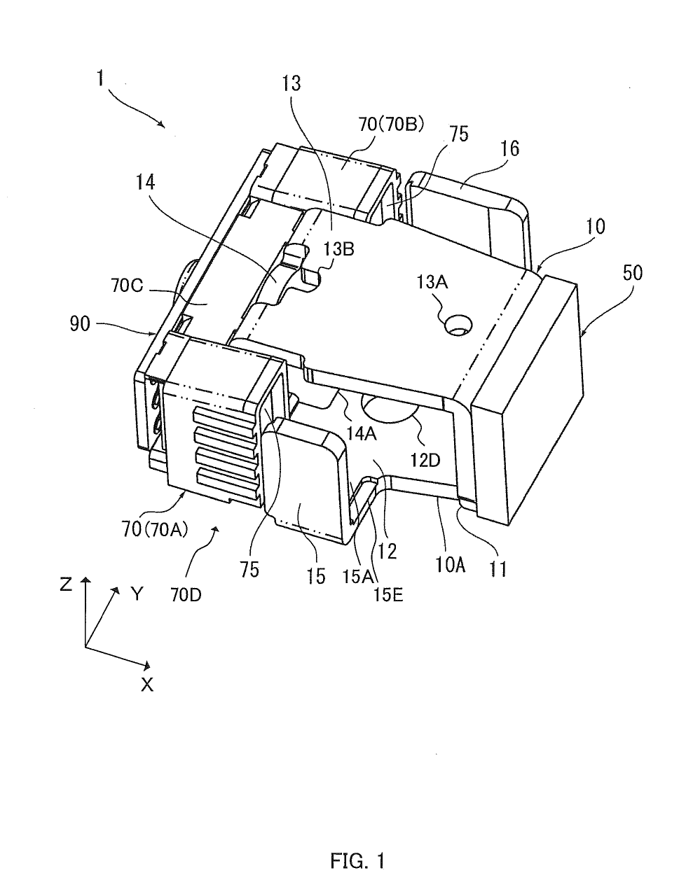

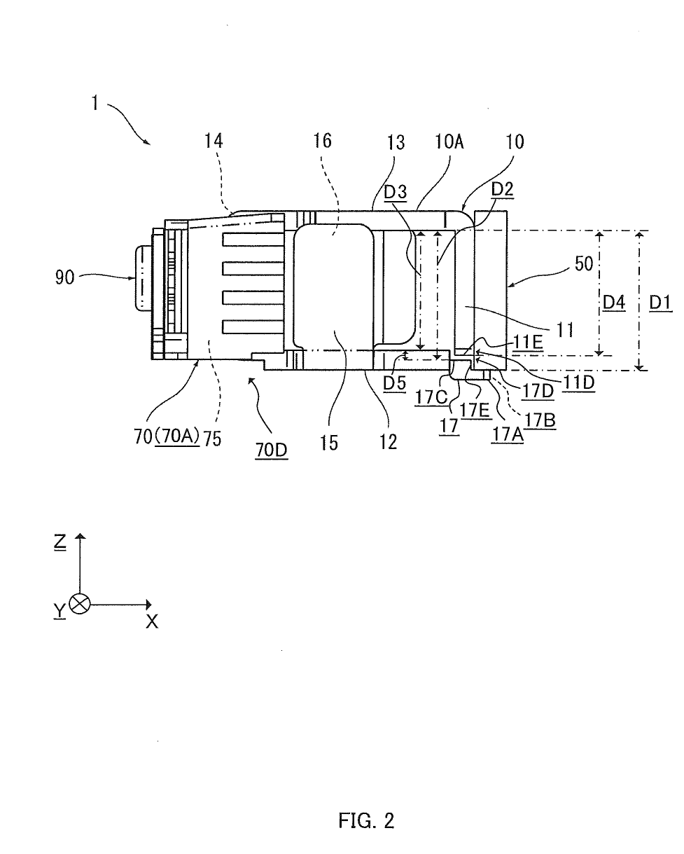

FIGS. 1 and 2 depict a first embodiment of a driving apparatus frame, a driving apparatus, and a pickup unit according to the present invention.

FIG. 1 is a perspective view of a part of an objective lens driving apparatus according to an embodiment of the present invention. FIG. 2 is a side view of a part of the objective lens driving apparatus according to an embodiment of the present invention.

An optical pickup unit configuring a driving apparatus assembly of a disc unit (not shown) is configured to support: a “CD” (Compact Disc) (trademark) series/standard medium; a “DVD” (registered trademark) (Digital Versatile Disc) series/standard medium; an “HD DVD” (High Definition DVD) (registered trademark) series/standard medium; a “CBHD (China Blue High-Definition)” (e.g., former name “CH-DVD”) series/standard medium, recognized as a medium based on the standard specified in China; and a “BD” (Blu-ray/Blu-ray Disc) (registered trademark) series/standard medium, for example. The optical pickup unit configuring the driving apparatus assembly of the disc unit is configured to support at least one type of medium selected from a group including the above types of media, for example. To be more specific, the optical pickup unit configuring the driving apparatus assembly of the disc unit is configured to support any of the above plurality of media. Medium (media) means a disc, etc., storing data, information, signals, etc.

The media include the above-described various types of optical discs, etc., for example, but can also include the media of the following types. For example, the disc includes the optical disc, etc., having a signal surface portions on both sides of the disc and capable of data writing/erasing, data rewriting, etc. Further, the disc includes the optical disc, etc., having a two-layer signal surface portion and capable of data writing/erasing, data rewriting, etc., for example. Further, the disc includes the optical disc, etc., for “HD DVD” and/or “Blu-ray/Blu-ray Disc” having a three-layer signal surface portion and capable of data writing/erasing, data rewriting, etc., for example. Further, the disc includes the optical disc, etc., for “Blu-ray/Blu-ray Disc” having a four-layer signal surface portion and capable of data writing/erasing, data rewriting, etc., for example. Further, the disc includes the optical disc, etc., capable of various writing, etc., on a label, etc., by irradiation of a laser beam (LASER: Light Amplification by Stimulated Emission of Radiation) onto the label face of the optical disc, for example. The signal surface portion and the label face portion of the optical disc includes a thin layer, etc., such as a metal thin film, for example. Data, information, signals, etc., are recorded on the signal surface portion including the metal thin film, etc., and an image, etc., is recorded on the label face portion. The signal surface portion of the optical disc is configured as a signal layer including a metal thin layer, for example. As such, the various types of optical discs include the optical discs having double-layer/multi-layer-structure.

This optical pickup unit is assumed to be the optical pickup unit capable of executing at least one of: reproduction of data, information, signals, etc., recorded in various media such as the various optical discs, such as “CD” (Compact Disc) (trademark), “DVD” (registered trademark) (Digital Versatile Disc), “HD DVD” (High-Definition DVD) (registered trademark), “CBHD” (China Blue High-Definition), “BD” (Blu-ray/Blu-ray Disc) (registered trademark), etc.; recording of data, information, signals, etc., in various media such as various writable or rewritable optical discs; and erasing of data, information, signals, etc., recorded in various media such as various writable or rewritable optical discs.

When passing a current through a coil configuring an actuator 1 to drive the coil, a reaction force by a magnetic force is generated in a magnet 50. In the case where such an event occurs, if a frame/yoke 10 attached with the magnet 50 has low strength, the reaction force applied to the magnet 50 excites resonance of the frame/yoke 10, which may adversely affect loop characteristics, etc., of the optical pickup unit, for example. Thus, the frame/yoke 10 is required to be increased in strength as much as possible, and increased in natural resonance frequency. The frame actuator 1 is assumed to have a configuration capable of equipping the frame/yoke 10 with the magnet 50 and a support component for supporting a moving part.

The yoke means something to structurally support a magnetic connection, for example, such as a magnetic connection member. The yoke is assumed to be something to reduce leakage of a magnetic force generated by a magnetic member such as a magnet. For example, a back yoke having the magnetic member such as the magnet mounted thereon is used as the yoke. For example, the back yoke may be handled as the frame/yoke. The frame means a frame, a framework, and structure, for example. The frame/yoke is formed as the frame with the function of the yoke.

This driving apparatus frame 10 is configured as an actuator frame/yoke 10 including a metal frame/yoke main body 10A capable of being equipped with the magnet 50 such as the magnet. The frame/yoke main body 10A is closed in a substantially boxlike shape when viewed from the side.

The frame/yoke main body 10A configuring the frame/yoke 10 for the actuator 1 is formed in the substantially boxlike shape with six (a plurality of) bent portions (portions) of a first bent portion 11, a fourth bent portion 12, a third bent portion 13, a second bent portion 14, a fifth bent portion 15, and a sixth bent portion 16.

A metal material is used to perform punching processing, bending processing, etc., for one sheet of the metal material, thereby forming the frame/yoke main body 10A. When the frame/yoke main body 10A is closed in the substantially boxlike shape when viewed from the side, the first bent portion 11 and the fourth bent portion 12 configuring the frame/yoke main body 10A are undetachably joined by an adhesive used when the magnet 50 is attached to the frame/yoke main body 10A, substantially simultaneously with a bonding process of the magnet 50.

The one is also usable that is formed by crimping and undetachably joining the first bent portion 11 and the fourth bent portion 12 configuring the frame/yoke main body 10A when the frame/yoke main body 10A is closed in the substantially boxlike shape when viewed from the side. The one is further usable that is formed by combined process of the bonding and crimping.

This objective lens driving apparatus 1 is configured as the actuator 1 including at least the actuator frame/yoke 10 and the magnet 50 attached to the actuator frame/yoke 10.

This pickup unit is configured as the optical pickup unit capable of emitting a laser beam, which includes: at least the actuator 1 having the actuator frame/yoke 10 and the magnet 50 attached to the actuator frame/yoke 10; and the objective lens to be driven by the actuator 1 substantially along at least one direction of an up-and-down movement, a right-and-left movement, and a rotational movement, for example.

With the frame/yoke main body 10A being configured as a closed structure in substantially boxlike shape when viewed from the side, the strength of the frame/yoke main body 10A can be increased without a separate component such as a cover being attached thereto. The effect of reduction in the number of components and man-hours can also be expected.

This pickup unit includes: a damping material (not shown) made of substantially gel-like synthetic polymer, for example, that suppresses abnormal vibration, etc., generated in a suspension wire as an elastic support member; and a damping holding member 70 made of synthetic resin that holds the damping material, for example. Suspension wires are inserted, respectively, into holes 75 of the damping holding member 70 made of the synthetic resin attached to the rear side of a metallic back yoke.

The holes 75 of the damping holding member 70 into which the suspension wires are inserted are filled with a flexible damping material made of the synthetic polymer, a so-called damping agent, for example. The damping holding member 70 is formed using a synthetic resin material of excellent insulation properties.

This optical pickup unit includes a circuit board 90 to which metal suspension wires as the elastic support member is connected and attached in an electrically conductive manner. The circuit board is called PWB (printed wired board/printed wiring board), etc., for example. The board itself of the circuit board 90 is formed using the synthetic resin material of excellent insulation properties. A circuit conductor (not shown) on the board itself made of the synthetic resin is formed as metallic foil of excellent conductivity. The board itself made of the synthetic resin on which the metallic circuit conductor not shown is formed is applied with the synthetic resin material of excellent insulation properties, thereby forming an insulation coat (not shown) over the synthetic-resin board itself having the metallic circuit conductor formed thereon.

According to the present invention, with the frame main body being configured to have a closed structure in the substantially boxlike shape, the strength of the frame main body can be increased without the separate components being attached thereto. The effect of reduction in the number of components and man-hours can also be expected.

A description will be given of the above described contents.

### Objective Lens Driving Apparatus

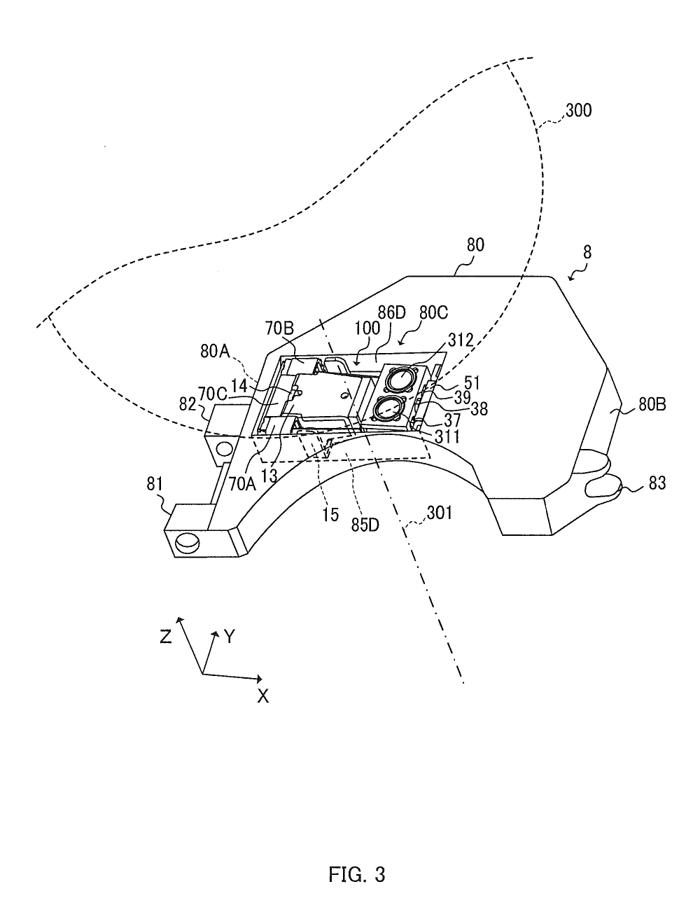

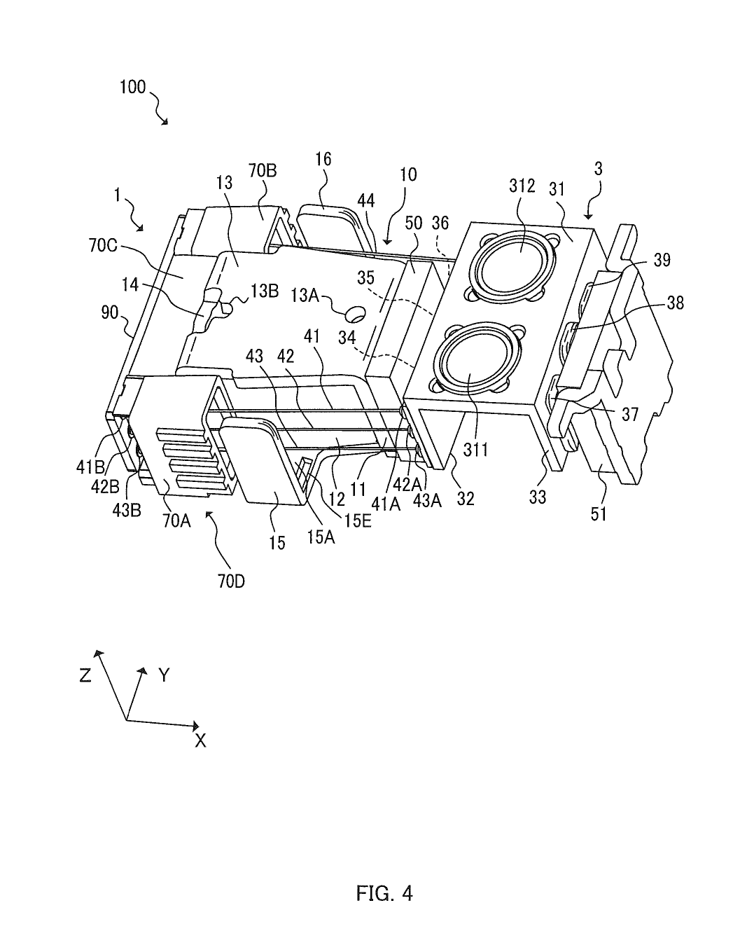

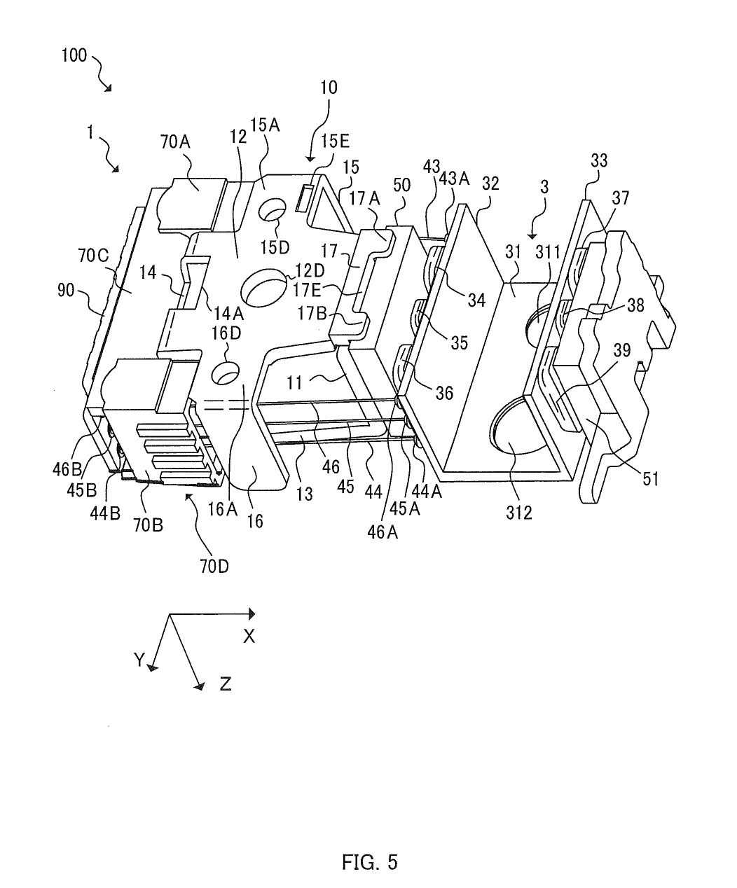

The objective lens driving apparatus according to an embodiment of the present invention will now be described with reference FIGS. 3 to 5. FIG. 3 is a perspective view illustrating a housing according to an embodiment of the present invention. For convenience of description, an optical disc 300 is illustrated by a dotted line and a part of the optical disc 300 is omitted. A rotation axis 301 of a spindle motor to rotate the optical disc 300 is illustrated by a dashed line for convenience of description. A fifth bent portion 15 and a side wall 85D, though invisible, are illustrated by the dotted line for convenience of description. FIG. 4 is a perspective view illustrating the objective lens driving apparatus when viewed from the side on which the objective lenses are exposed in an embodiment of the present invention. FIG. 5 is a perspective view illustrating the objective lens driving apparatus viewed from the side to which foot plates extend in an embodiment of the present invention.

In an embodiment of the present invention, Z axis is an axis along a longitudinal direction (focusing direction, vertical direction) of the rotation axis 301 of the spindle motor for rotating the optical disc, and it is assumed that the direction from the housing 80 to the optical disc 300 is +Z direction and the direction from the optical disc 300 to the housing 80 is −Z direction. Y axis is an axis along the direction in which an optical pickup unit 8 moves in the radial direction (tracking direction) of the optical disc 300, and it is assumed that the direction of departing from the rotation axis 301 is +Y direction and the direction of approaching the rotation axis 301 is −Y direction. X axis is an axis along the tangential direction, and it is assumed that the direction from the exterior of the housing 80 toward a side face 80A is +X direction and the direction from the exterior of the housing 80 toward a side face 80B is −X direction.

An objective lens driving apparatus 100 includes a first objective lens 311, a second objective lens 312, a lens holder 3, and the actuator 1.

The first objective lens 311 and the second objective lens 312 condense a laser beam emitted from a laser diode (not shown) housed in the housing 80 onto a signal recording surface of the optical disc 300. The signal recording surface of the optical disc 300 is an underside (−Z) surface of the optical disc 300 opposing the first objective lens 311 and the second objective lens 312 in the optical disc 300. It is assumed that the first objective lens 311 and the second objective lens 312 condense laser beams having wavelengths different from each other onto the signal recording surface of the optical disc 300, for example.

The lens holder 3 is a device to hold the first objective lens 311 and the second objective lens 312. The lens holder 3 includes a holding plate 31 and foot plates 32 and 33.

The holding plate 31 is a member to hold the first objective lens 311 and the second objective lens 312. The holding plate 31 is a resin-made plate member of a rectangular shape having a longer side along the tracking direction and a shorter side along the tangential direction, for example. The holding plate 31 holds the first objective lens 311 and the second objective lens 312 so that the first objective lens 311 and the second objective lens 312 are adjacent to each other along the tracking direction. The holding plate 31 holds the first objective lens 311 and the second objective lens 312 so that the first objective lens 311 and the second objective lens 312 are exposed on the upper side (+Z) to oppose the signal recording surface of the optical disc 300.

The foot plate 32 is a resin-made plate member of a rectangular shape, for example. The foot plate 33 is the resin-made plate member of a shape similar to that of the foot plate 32. The foot plates 32 and 33 extend, respectively, from the long side of the holding plate 31 on the yoke 10 side (−X) and the long side of the holding plate 31 on the side opposite to the yoke 10 (+X) toward the side opposite to the optical disc 300 (−Z) in the focusing direction. The holding plate 31 and the foot plates 32 and 33 are formed in a U-shape when viewed toward +Y side along the tracking direction. The foot plates 32 and 33 are formed line-symmetrically with respect to the central axis along the tracking direction passing through the center between the foot plates 32 and 33, for example.

The actuator 1 is a device to displace the lens holder 3 in the focusing direction or the tracking direction of the optical disc 300.

### Actuator

The actuator according to an embodiment of the present invention will hereinafter be described with reference to FIGS. 4 and 5.

The actuator 1 includes the circuit board 90, a support body 70D, the yoke 10, suspension wires 41 to 46, magnets 50 and 51, first focus coils 34 and 37, second focus coils 36 and 39, and tracking coils 35 and 38.

The first focus coils 34 and 37 are a pair of coils, formed by winding one conductive wire supplied with a focusing signal for displacing the lens holder 3 in the focusing direction. The second focus coils 36 and 39 are a pair of coils, formed by winding one conductive wire supplied with the focusing signal to displace the lens holder 3 in the focusing direction. The tracking coils 35 and 38 are a pair of coils, formed by winding one conductive wire supplied with a tracking signal to displace the lens holder 3 in the tracking direction. The first focus coil 34, the second focus coil 36, and the tracking coil 35 are attached to the exterior (-X) surface of the foot plate 32 opposing the magnet 50. The first focus coil 37, the second focus coil 39, and the tracking coil 38 are attached to the exterior (+X) surface of the foot plate 33 opposing the magnet 51. The first focus coils 34 and 37 are provided on the exterior surfaces of the foot plates 32 and 33, respectively, and are formed by winding one conductive wire around a coil bobbin (not shown) along the tangential direction. The second focus coils 36 and 39 are provided on the exterior surfaces of the foot plates 32 and 33, respectively, and are formed by winding one conductive wire around the coil bobbin (not shown) along the tangential direction. The tracking coils 35 and 38 are provided on the exterior surfaces of the foot plates 32 and 33, respectively, and are formed by winding one conductive wire around the coil bobbin (not shown) along the tangential direction. The first focus coil 34 and the second focus coil 36 are attached to the foot plate 32 so as to be symmetric with respect to the tracking coil 35 along the tracking direction. The first focus coil 37 and the second focus coil 39 are attached to the foot plate 33 so as to be symmetric with respect to the tracking coil 38 along the tracking direction.

The magnets 50 and 51 are a magnetic body that generates magnetic flux for displacing the lens holder 3 in the focusing direction or the tracking direction. The magnets 50 and 51 are of a substantially rectangular shape having two opposed sides in the tracking direction and two opposed sides in the focusing direction, for example. The magnet 51 is fixed to the housing 80 so as to oppose the first focus coil 37, the second focus coil 39, and the tracking coil 38 in the tangential direction when the objective lens driving apparatus 100 is fixed to the housing 80. The magnet 50 is attached to the yoke 10 so as to oppose the first focus coil 34, the second focus coil 36, and the tracking coil 35 in the tangential direction. That is to say, the magnet 50 is adjacent to the lens holder 3 via the first focus coil 34, the second focus coil 36, and the tracking coil 35 in the tangential direction of the optical disc 300. A magnetic field generated at the magnet 50 effectively acts on the first focus coil 34, the second focus coil 36, and the tracking coil 35 so that an electromagnetic force for displacing the lens holder 3 in the focusing direction and the tracking direction is generated.

The yoke 10 is a metallic member to reduce the leakage of magnetic flux generated at the magnets 50 and 51 and to reliably displace the lens holder 3 in the focusing direction or the tracking direction. Further, the yoke 10 is attached with the magnet 50 to oppose the first focus coil 34, the second focus coil 36, and the tracking coil 35, and also functions as the frame of the objective lens driving apparatus 100 for fixing the objective lens driving apparatus 100 to the housing 80. The yoke 10 is adjacent to the magnet 50 on the side opposite to the lens holder 3 in the tangential direction. The yoke 10 is configured to be capable of suppressing the deformation of the yoke 10 which is caused by the resonance of the yoke 10 when displacing the lens holder 3 in the focusing direction or the tracking direction. The resonance and the yoke 10 will be described later.

The support body 70D is a member to support the suspension wires 41 to 46. The suspension wires 41 to 46 will be described later. The support body 70D is fixed to the yoke 10 on the side opposite to the magnet 50 in the tangential direction. The support body 70D includes holding members 70A and 70B and a fixing member 70C. The fixing member 70C is a member to support the holding members 70A and 70B and to fix the support body 70D to the yoke 10. The fixing member 70C is, for example, bonded to the second bent portion 14 of the yoke 10. The fixing member 70C supports the holding members 70A and 70B so that the holding members 70A and 70B are arranged, respectively, on the −Y side and the +Y side of the fixing member 70C. The holding member 70A is a member to support the suspension wires 41 to 43 and damp vibration thereof with the damping agent surrounding the suspension wires 41 to 43 injected. The holding member 70B is a member to support the suspension wires 44 to 46 and damp vibration thereof with the damping agent surrounding the suspension wires 44 to 46 injected.

The circuit board 90 is a board that supplies the focusing signal and the tracking signal, and is provided by screws on the support body 70D on the side opposite to the yoke 10 in the tangential direction. An end portion on the −Y side of a surface of the circuit board 90 on the support body 70D side (+X) is provided with terminals 41B, 42B, and 43B which are electrically connected to a circuit to output the focusing signal and the tracking signal of the circuit board 90.

The terminals 41B, 42B, and 43B are provided along the focusing direction. For example, the terminal 42B is provided on the upper side (+Z) of the terminal 43B and the terminal 41B is provided on the upper side (+Z) of the terminal 42B. An end portion on the +Y side of the surface of the circuit board 90 on the support body 70D side are provided with terminals 44B, 45B, and 46B which are electrically connected to the circuit to output the focusing signal and the tracking signal of the circuit board 90. The terminals 44B, 45B, and 46B are provided along the focusing direction. For example, the terminal 45B is provided on the upper side of the terminal 46B and the terminal 44B is provided on the upper side of the terminal 45B.

The suspension wires 41 to 46 elastically support the lens holder 3 so that the lens holder 3 can be displaced in the focusing direction and the tracking direction. The suspension wires 41 to 46 function also as signal lines that send the focusing signal and the tracking signal to displace the lens holder 3 in the tracking direction and the focusing direction. The suspension wires 41 to 43 support the lens holder 3 on the front side (−Y) in the tracking direction, and extend along the tangential direction. The suspension wires 44 to 46 support the lens holder 3 on the rear side (+Y) in the tracking direction and extend along the tangential direction. It is assumed that the suspension wires 41 to 46 extend such that the magnet 50 and the first bent portion 11, the second bent portion 14, and the third bent portion 13 of the yoke 10 are arranged between the suspension wires 41 to 43 and the suspension wires 44 to 46, for example.

One ends of the suspension wires 41 to 43 are fixed to an end portion on the front side of a surface of the foot plate 32 on the yoke 10 side (−X), using soldering, etc., for example. Further, one ends of the suspension wires 41 and 43 are electrically connected by use of solder, etc., for example, to terminals 41A and 43A, respectively, which are electrically connected to both ends of a pair of the first focus coils 34 and 37. One end of the suspension wire 42 is electrically connected, by use of the solder, etc., for example, to the terminal 42A which is electrically connected to one end of a pair of the tracking coils 35 and 38. The other ends of the suspension wires 41 to 43 are fixed to an end portion on the front side of the surface of the circuit board 90 on the yoke 10 side via the holding member 70A, using the soldering, etc., for example, and are electrically connected by use of the solder, etc., for example, to the terminals 41B, 42B, and 43B of the circuit board 90, respectively. It is assumed that the terminals 41A, 42A, and 43A are provided along the focusing direction. It is assumed that the terminal 42A is provided on the upper side of the terminal 43A and that the terminal 41A is provided on the upper side of the terminal 42A, for example.

One ends of the suspension wires 44 to 46 are fixed to an end portion on the rear side of the surface of the foot plate 32 on the yoke 10 side, using the soldering, etc., for example. Further, one ends of the suspension wires 44 and 46 are electrically connected by use of the solder, etc., for example, to terminals 44A and 46A, respectively, which are electrically connected to both ends of a pair of the second focus coils 36 and 39. One end of the suspension wire 44 is electrically connected, by use of the solder, etc., for example, to the terminal 45A which is electrically connected to the other end of a pair of the tracking coils 35 and 38. The other ends of the suspension wires 44 to 46 are fixed to an end portion on the rear side the surface of the circuit board 90 on the yoke 10 side via the holding member 70B, using the soldering, etc., for example, and are electrically connected by use of the solder, etc., for example, to the terminals 44B, 45B, and 46B of the circuit board 90, respectively. It is assumed that the terminals 44A, 45A, and 46A are provided along the focusing direction. It is assumed that the terminal 45A is provided on the upper side of the terminal 46A and that the terminal 44A is provided on the upper side of the terminal 45A, for example.

### Resonance

The resonance of the yoke according to an embodiment of the present invention will hereinafter be described with reference to FIGS. 4 and 5.

Based on the focusing signal supplied to the first focus coils 34 and 37 and the second focus coils 36 and 39 and the magnetic flux generated at the magnets 50 and 51, the electromagnetic force in the focusing direction is generated with respect to the first focus coils 34 and 37 and the second focus coils 36 and 39. This electromagnetic force displaces the lens holder 3 in the focusing direction. Based on the tracking signal supplied to the tracking coils 35 and 38 and the magnetic flux generated at the magnets 50 and 51, an electromagnetic force in the tracking direction is generated with respect to the tracking coils 35 and 38. This electromagnetic force displaces the lens holder 3 in the tracking direction.

For example, when the lens holder 3 is displaced in the focusing direction from the lower side (−Z), where the foot plates 32 and 33 project, to the upper side (+Z), where the first objective lens 311 and the second objective lens 312 are exposed, the magnets 50 and 51 are subject to the reaction force from the upper side to the lower side by counteraction of the electromagnetic force that displaces the lens holder 3 from the lower side to the upper side. For example, when the lens holder 3 is displaced in the focusing direction from the upper side to the lower side, the magnets 50 and 51 are subject to the reaction force from the lower side to the upper side by the counteraction of the electromagnetic force that displaces the lens holder 3 from the upper side to the lower side. For example, when the lens holder 3 is displaced in the tracking direction from the front side (−Y) to the rear side (+Y), the magnets 50 and 51 are subject to the reaction force from the rear side to the front side by counteraction of the electromagnetic force that displaces the lens holder 3 from the front side to the rear side. For example, when the lens holder 3 is displaced in the tracking direction from the rear side to the front side, the magnets 50 and 51 are subject to the reaction force from the front side to the rear side by counteraction of the electromagnetic force that displaces the lens holder 3 from the rear side to the front side.

That is to say, in the actuator 1, when the lens holder 3 is displaced in the focusing direction or the tracking direction, the reaction force, to which the magnets 50 and 51 are subject, causes the yoke 10 to vibrate in the focusing direction or the tracking direction. This vibration of the yoke 10 results in resonance when the focusing signal or the tracking signal is at a predetermined frequency, for example,. The frequency of the focusing signal or the tracking signal at which the yoke 10 resonates is referred to as the resonance frequency. When the yoke 10 resonates, the amplitude of the vibration of the yoke 10 in the focusing direction or the tracking direction comparatively increases and the yoke 10 is deformed or the yoke 10 as a whole shakes comparatively greatly, possibly resulting in reduction in accuracy of displacement of the lens holder 3 in the focusing direction or the tracking direction. That is to say, the resonance of the yoke 10 may impair the control characteristics of displacement of the lens holder 3 in the focusing direction or the tracking direction in the objective lens driving apparatus 100. Thus, the yoke 10 is required to be reinforced to prevent the deformation of the yoke 10 by the reaction force of the magnet 50, and to shift the resonance frequency to the frequency band higher than the frequency band usually used as the frequency of the focusing signal and the tracking signal.

### Yoke

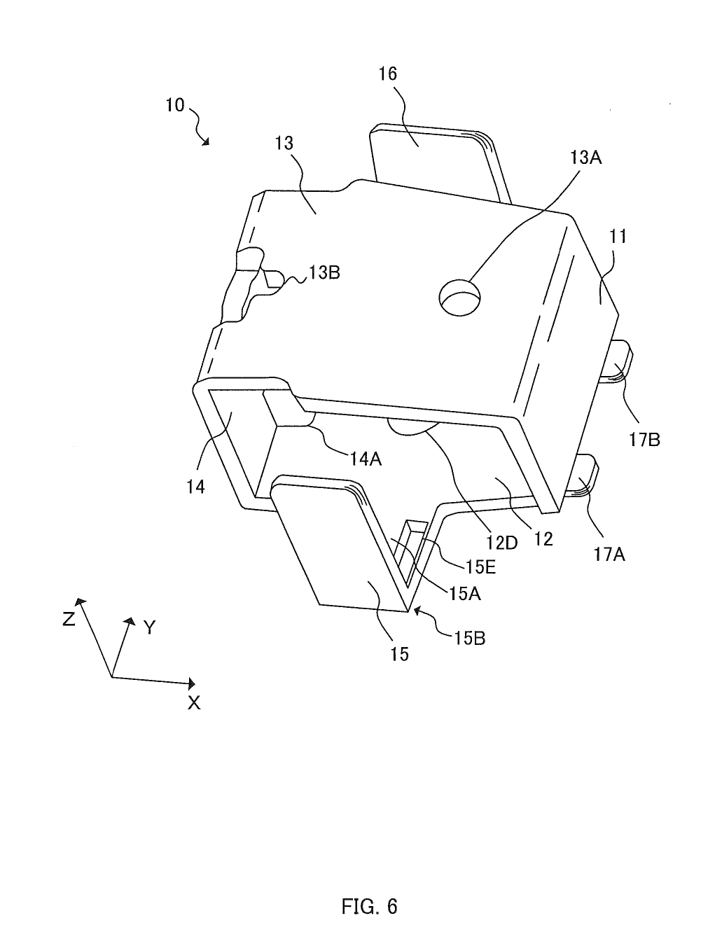

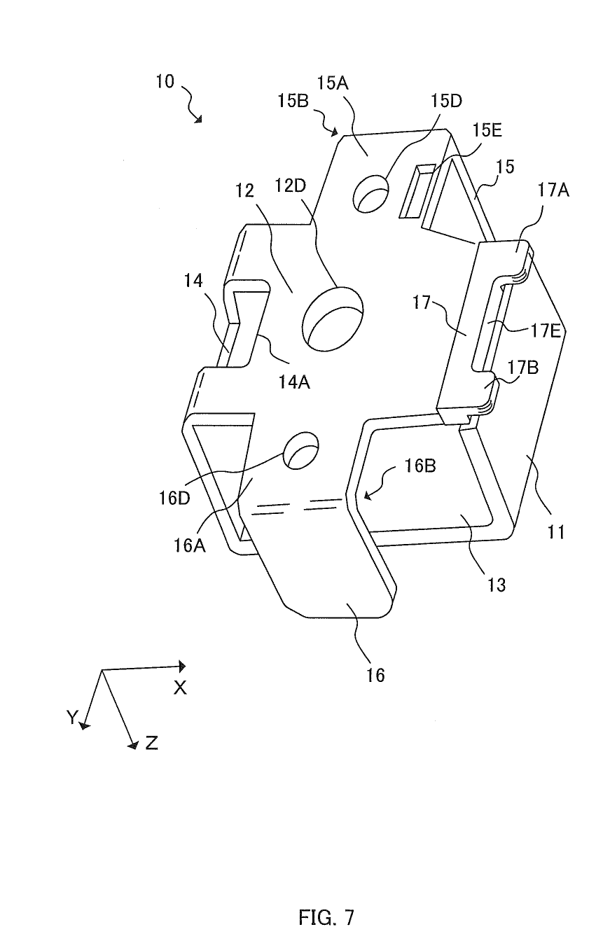

The yoke according to an embodiment of the present invention will hereinafter be described with reference to FIGS. 6 and 7.

FIG. 6 is a perspective view of the yoke when viewed from the side to which the fifth bent portion and the sixth bent portion according to an embodiment of the present invention extend. FIG. 7 is a perspective view of the yoke when viewed from the side opposite to the side to which the fifth bent portion and the sixth bent portion according to an embodiment of the present invention extend.

The yoke 10 is a ferromagnetic metallic member to reduce the leakage of the magnetic flux generated at the magnets 50 and 51 (FIG. 4) and to ensure the displacement of the lens holder 3 in the focusing direction or the tracking direction. Further, the yoke 10 also functions as the frame of the objective lens driving apparatus 100. The yoke 10 is provided between the magnet 50 and the circuit board 90 in the tangential direction. The yoke 10 is formed by bending one sheet of mild steel plate.

The yoke 10 includes the first bent portion 11, the second bent portion 14, the third bent portion 13, the fourth bent portion 12, the fifth bent portion 15, and the sixth bent portion 16. The first bent portion 11, the third bent portion 13, the second bent portion 14, and the fourth bent portion 12 are formed by bending one sheet of metal plate into the rectangular shape, around the axis of the tracking direction. The fifth bent portion 15 extends from one end portion 15B of the fourth bent portion 12 in the tracking direction toward the optical disc 300 (FIG. 3) (+Z direction). The sixth bent portion 16 extends from the other end portion 16B of the fourth bent portion 12 in the tracking direction toward the optical disc 300.

### First to Fourth Bent Portions

The first bent portion 11 is a member to attach the magnet 50 to the yoke 10. The first bent portion 11 is of a substantially rectangular flat plate shape, substantially parallel to the YZ plane formed by the tracking direction and the focusing direction. The first bent portion 11 includes end portions that are along the tracking direction and are opposed to each other in the focusing direction. The first bent portion 11 includes end portions that are along the focusing direction and are opposed to each other in the tracking direction. The first bent portion 11 is formed such that a surface thereof on the magnet 50 side (+X) (hereinafter referred to as “one side” as well) opposes a surface of the magnet 50 on the yoke 10 side (−X) (hereinafter referred to as “the other side” as well). The magnet 50 is fixed, with the adhesive, to the surface of the first bent portion 11 on the one side. The fixing of the magnet 50 to the first bent portion 11 will be described later.

The third bent portion 13 is of a shape formed by being bent at substantially right angle from the end of the first bent portion 11 on the side close to the optical disc 300 (+Z) in the focusing direction toward the side opposite to the magnet 50 (−X) in the tangential direction. The third bent portion 13 is of a flat plate shape, substantially parallel to the XY plane formed by the tracking direction and the tangential direction. That is to say, the third bent portion 13 is bent so that the surface thereof on the upper side (+Z) opposes the optical disc 300. The length in the tracking direction of a part of the third bent portion 13 on the side opposite to the magnet 50 is set so as to be comparatively short so that the third bent portion 13 does not interfere with the holding members 70A and 70B (FIG. 4). A part of an end portion of the third bent portion 13 on the other side in the tangential direction is bored toward one side so that a hole 13B is formed for reduction in weight of the yoke 10, for example. The third bent portion 13 has a hole 13A formed for reduction in weight of the yoke 10, for example.

The second bent portion 14 is a member to fix the support body 70D to the yoke 10. The second bent portion 14 is of a shape formed by being bent at substantially right angle from the end of the third bent portion 13 on the side opposite to the magnet 50 in the tangential direction toward the side opposite to the optical disc 300 (−Z) in the focusing direction. The second bent portion 14 is of a flat plate shape, substantially parallel to the first bent portion 11. That is to say, the second bent portion 14 is bent so that a surface thereof on the one side opposes a surface on the other side of the first bent portion 11. A part of an end portion of the second bent portion 14 on the lower side (−Z) in the focusing direction is bored toward the upper side so that a hole 14A is formed for reduction in weight of the yoke 10, for example. The fixing member 70C is bonded to a surface of the second bent portion 14 on the other side using the adhesive, for example.

The fourth bent portion 12 is a member to fix the yoke 10 to the housing 80. The fourth bent portion 12 is of a shape formed by being bent at substantially right angle from the end of the second bent portion 14 on the side farther from the optical disc 300 (−Z) in the focusing direction toward the magnet 50 (+X direction). The fourth bent portion 12 is of a flat plate shape, substantially parallel to the third bent portion 13. That is to say, the fourth bent portion 12 is bent so that a surface thereof on the upper side opposes a surface on the lower side of the third bent portion 13. The fourth bent portion 12 is of a shape having a part thereof 15A (FIG. 7) on the −Y side and a part thereof 16A on the +Y side in the tracking direction extending away from the center of the fourth bent portion 12 along the tracking direction. A part of an end portion of the fourth bent portion 12 on the other side in the tangential direction is bored toward one side so that the hole 14A is formed. The fourth bent portion 12 has a plurality of holes 15D, 15E, 12D, and 16D formed for reduction in weight of the yoke 10, for example. An end portion 17 (FIG. 2) of the fourth bent portion 12 on the one side in the tangential direction opposes an end portion 11D of the first bent portion 11 on the lower side in the focusing direction and the surface of the magnet 50 on the other side. The end portions 17 and 11D will be described later.

### Fifth and Sixth Bent Portions

The fifth bent portion 15 is a member to fix the yoke 10 to the housing 80. The fifth bent portion 15 is of a shape formed by being bent at substantially right angle from one end 15B of a part 15A of the fourth bent portion 12 in the tracking direction toward the optical disc 300 (+Z direction). That is to say, the fifth bent portion 15 extends from the one end portion 15B in the tracking direction of the fourth bent portion 12 toward the optical disc 300. The fifth bent portion 15 is of a substantially rectangular flat plate shape, substantially parallel to the XZ plane formed by the tangential direction and the focusing direction.

It is assumed that the fourth bent portion 12 is provided lower than the suspension wires 43 and 46, for example. Further, it is assumed that a part 15A of the fourth bent portion 12 is formed so that one end portion 15B is arranged on the −Y side of the suspension wires 41 to 43. It is assumed that the length in the focusing direction of the fifth bent portion 15 is set so as to be longer than the distance from the fourth bent portion 12 to the suspension wire 41 in the focusing direction, for example. Thus, the suspension wires 41 to 43 are arranged between the first bent portion 11, the second bent portion 14, the third bent portion 13, and the fourth bent portion 12; and the fifth bent portion 15. Therefore, the suspension wires 41 to 43 are protected by the fifth bent portion 15.

The sixth bent portion 16 is a member to fix the yoke 10 to the housing 80. The sixth bent portion 16 is of a shape formed by being bent at substantially right angle from the other end portion 16B of the fourth bent portion 12 in the tracking direction of a part 16A toward the optical disc 300. That is to say, the sixth bent portion 16 extends from the other end portion 16B in the tracking direction of the fourth bent portion 12 toward the optical disc 300. The sixth bent portion 16 is of a substantially rectangular flat plate shape, substantially parallel to the fifth bent portion 15.

It is assumed that a part 16A of the fourth bent portion 12 is formed so that the other end portion 16B is arranged on the +Y side of the suspension wires 44 to 46.

It is assumed that the length in the focusing direction of the sixth bent portion 16 is set so as to be longer than the distance from the fourth bent portion 12 to the suspension wire 44 in the focusing direction, for example. Thus, the suspension wires 44 to 46 are arranged between the first bent portion 11, the second bent portion 14, the third bent portion 13, and the fourth bent portion 12; and the sixth bent portion 16. Therefore, the suspension wires 44 to 46 are protected by the sixth bent portion 16.

### End Portion of First and Fourth Bent Portions

The end portion of the first bent portion and the end portion of the fourth bent portion according to an embodiment of the present invention will now be described with reference to FIG. 2.

The end portion 17 of the fourth bent portion 12 on the magnet 50 side (+X) in the tangential direction and the end portion 11D of the first bent portion 11 on the side opposite to the optical disc 300 (−Z) in the focusing direction are one end portion and the other end portion respectively, of one sheet of metal plate forming the yoke 10.

The end portion 11D is formed along the tracking direction. The end portion 11D includes an opposed surface 11E. The opposed surface 11E is formed at such a position that a distance D4 in the focusing direction from a surface (−Z) on the inner side of the third bent portion 13 opposing the fourth bent portion 12 to the opposed surface 11E is set so as to be longer than a distance D3 in the focusing direction from the surface on the inner side of the third bent portion 13 to an surface on the inner side (+Z) of the fourth bent portion 12 opposing the third bent portion 13. That is to say, the opposed surface 11E is formed lower (−Z) than the surface on the inner side of the fourth bent portion 12.

The end portion 17 is formed along the tracking direction. The end portion 17 includes opposed surfaces 17C and 17E and projecting portions 17A and 17B.

The opposed surface 17C is a surface opposing the opposed surface 11E. The opposed surface 17C is formed at such a position that a distance D2 in the focusing direction from the surface on the inner side of the third bent portion 13 to the opposed surface 17C is longer than distance D4. The opposed surface 17C is formed to oppose the opposed surface 11E from the lower side in the focusing direction. A space is formed between the opposed surface 17C and the opposed surface 11E. That is to say, the opposed surface 17C and the opposed surface 11E oppose each other in the focusing direction via the space between the opposed surfaces 17C and 11E.

The opposed surface 17E is a surface opposing the surface of the magnet 50 on the other side (−X). The opposed surface 17E is formed at a position on the second bent portion side (−X) with respect to the surface of the first bent portion 11 on the magnet side in the tangential direction so that a space is created between the opposed surface 17E and the surface of the magnet 50 on the other side when the surface of the magnet 50 on the other side abuts against the surface of the first bent portion 11 on the magnet 50 side (+X).

The projecting portions 17A and 17B are portions for performing positioning of the magnet 50 with respect to the yoke 10. The projecting portions 17A and 17B are of such a shape as to project from the opposed surface 17E of the end portion 17 toward the lens holder 3, for example. The projecting portions 17A and 17B are provided at the positions farther from each other by a predetermined distance in the tracking direction so that the positioning of the magnet 50 with respect to the yoke 10 can be easily performed. The projecting portions 17A and 17B are of such a shape that, when performing positioning of the magnet 50 with respect to the yoke 10, the end portion of the magnet 50 on the side farther from the optical disc 300 (−Z) in the focusing direction abuts against surfaces on the upper side (+Z) of the projecting portions 17A and 17B. The projecting portions 17A and 17B are formed such that a distance D1 in the focusing direction from the surface on the inner side of the third bent portion 13 to the surfaces on the upper side of the projecting portions 17A and 17B is longer than the distance D2. Further, a distance D5 in the focusing direction from the opposed surface 17C to the surfaces on the upper side of the fourth bent portion 12 is set so as to be comparatively short so that, when the end portion on the side farther from the optical disc 300 (−Z) of the magnet 50 abuts on the surfaces of the projecting portions 17A and 17B on the upper side, the end portion on the side farther from the optical disc 300 of the magnet 50 opposes the end portion 17 and the end portion 11D.

### Fixing of Magnet

The fixing of the magnet to the yoke in an embodiment of the present invention will now be described with reference to FIGS. 2 and 5.

The magnet 50 is fixed to the yoke 10, using a thermosetting adhesive, for example.

The magnet 50 is fixed to the yoke 10, using the adhesive after the positioning thereof performed with respect to the yoke 10, for example.

The positioning of the magnet 50 with respect to the yoke 10 is performed by causing the surfaces opposed to each other of the first bent portion 11 and the magnet 50 to abut against each other as well as causing the surface on the lower side (−Z) of the magnet 50 to abut against the surfaces on the upper side (+Z) of the projecting portions 17A and 17B, for example. When the positioning of the magnet 50 is performed with respect to the yoke 10, a space 17D is formed which continues from the space between the opposed surface 17E and the surface of the magnet 50 on the first bent portion 11 side (−X) to the space between the opposed surface 11E and the opposed surface 17C.

For example, in state where the yoke 10 is turned over so that the third bent portion 13 is on the lower side, the adhesive to fix the magnet 50 to the yoke 10 is applied between the opposed surface 17E and the magnet 50. The adhesive flows into the space 17D (bonding portion) under its own weight and/or penetrates into the space between the magnet 50 and the first bent portion 11, and then cures. It is assumed that the space 17D is filled with the adhesive and that a sufficient amount of the adhesive is applied so as to securely fix the magnet 50 to the yoke 10. The adhesive includes an adhesive, e.g., a one-component adhesive, having such a viscosity that the one flowing into the space 17D under its own weight and/or penetrating into the space between the magnet 50 and the first bent portion 11. The end portion 17 and the end portion 11D are bonded to each other. The magnet 50 is bonded to the first bent portion 11.

Thus, the yoke formed by bending a sheet of metal plate around the axis of the tracking direction has the first bent portion 11, the second bent portion 14, the third bent portion 13, and the fourth bent portion 12 coupled into the rectangular shape when viewed from the −Y direction toward the +Y direction. The end portion 17 and the end portion 11D are bonded to the magnet 50. Further, the surface of the first bent portion 11 opposing the magnet 50 is bonded to the surface of the magnet 50 opposing the first bent portion 11.

Since the adhesive is applied on the side opposite to the side opposing the optical disc 300 of the yoke 10, for example, even if a comparatively large amount of adhesive is applied to the yoke 10 and the adhesive cures with a mound made on the fourth bent portion 12 side, it does not interfere with the optical disc 300. Therefore, a sufficient amount of the adhesive can be applied to the yoke 10 so as to securely fix the magnet to the yoke 10 and to securely connect the end portion 11D and the end portion 17.

The surface of the magnet 50 on the side opposing the first bent portion 11 is equivalent to a first bonding surface. In the surface of the magnet 50 on the side opposing the first bent portion 11, a part thereof opposing the end portion 17 of the fourth bent portion 12 and a part thereof opposing the end portion 11D of the first bent portion 11 are equivalent to a second bonding surface.

### Fixing of Yoke to Housing

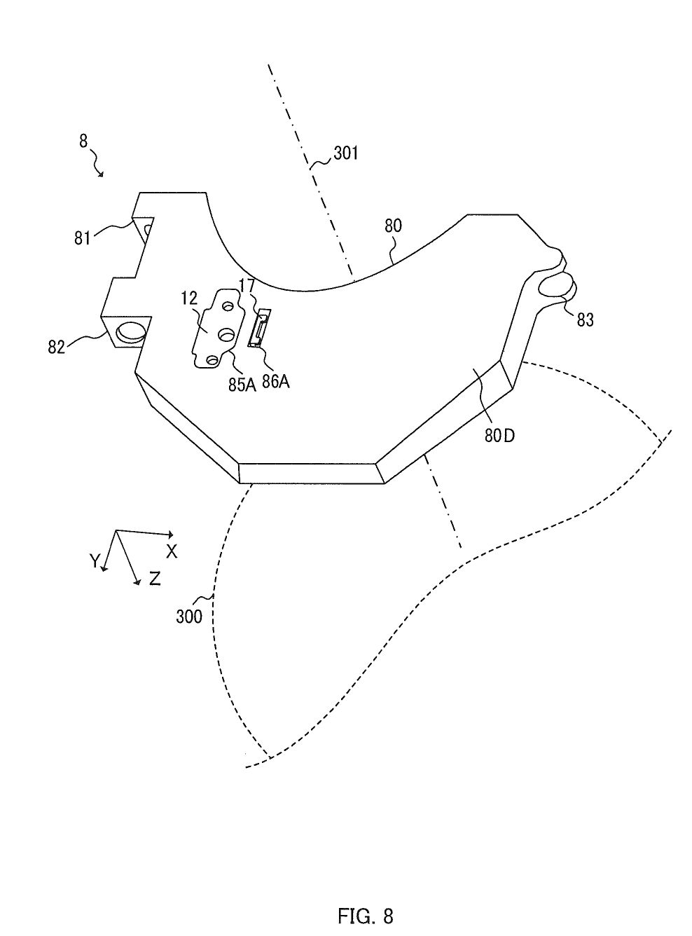

Fixing of the yoke to the housing according to an embodiment of the present invention will hereinafter be described with reference to FIGS. 3 and 8. FIG. 8 is a perspective view of the housing according to an embodiment of the present invention, when viewed from the side opposite to the side opposing the optical disc. For convenience of description, the optical disc 300 is illustrated by a dotted line and a part of the optical disc 300 is omitted. The rotation axis 301 of the spindle motor to rotate the optical disc 300 is illustrated by a dashed line for convenience of description.

The housing 80 is a resin-made container to house the objective lens driving apparatus 100 configuring the optical pickup unit 8 and an optical element configured to record information in the optical disc 300, for example. The front side (−Y) of the housing 80 opposing the rotation axis 301 is of a shape contoured with a predetermined curvature to avoid the spindle motor (not shown), for example. The housing 80 includes guide members 81, 82, and 83 and a hollow 80C.

The guide members 81, 82, and 83 are members configured to attach the housing 80 to a pair of guide axes for moving the optical pickup unit 8 along the radial direction (Y axis) of the optical disc 100. The guide members 81, 82, and 83 are provided on both side faces 80A and 80B. The guide member 83 is provided on the side face 80B on one side of the housing 80, for example. The guide members 81 and 82 are provided on the side face 80A on the other side of the housing 80, for example.

The hollow 80C is of such a shape as to house the objective lens driving apparatus 100. The hollow 80C is formed on the housing 80 on the side opposing the optical disc 300. The bottom of the hollow 80C is formed by a bottom plate 80D of the housing 80 on the side opposite to the side opposing the optical disc 300. When the objective lens driving apparatus 100 is housed in the hollow 80C, the objective lens driving apparatus 100 is placed on the bottom of the hollow 80C. Holes 85A and 86A are formed on a part of the bottom plate 80D forming the bottom of the hollow 80C. The holes 85A and 86A are holes for performing positioning the yoke 10 with respect to the housing 80 when fixing the yoke 10 to the bottom of the hollow 80C, for example. It is assumed that in the hollow 80C, side walls 85D and 86D are formed to oppose the fifth bent portion 15 and the sixth bent portion 16, respectively, when the objective lens driving apparatus 100 is arranged in the hollow 80C.

The yoke 10 is fixed to the housing 80 with the adhesive. The yoke 10 is fixed to the housing 80 with the fourth bent portion 12, the fifth bent portion 15, and the sixth bent portion 16 respectively bonded to the bottom, the side wall 85D, and the side wall 86D of the hollow 86C, for example.

As described above, the objective lens driving apparatus 100 includes the first objective lens 311, the second objective lens 312, the lens holder 3, and the actuator 1. The first objective lens 311 and the second objective lens 312 oppose the signal recording surface of the optical disc 300. The lens holder 3 holds the first objective lens 311 and the second objective lens 312. The actuator 1 displaces the lens holder 3 in the focusing direction or the tracking direction of the optical disc 300. The actuator 1 includes the first focus coil 34, the second focus coil 36, the tracking coil 35, the magnet 50, and the yoke 10. The first focus coil 34, the second focus coil 36, and the tracking coil 35 are attached to the lens holder 3. The magnet 50 generates the magnetic field effectively acting on the first focus coil 34, the second focus coil 36, and the tracking coil 35. The yoke 10 has the magnet 50 fixed thereto. Since the yoke 10 is formed by bending a sheet of metal plate into the rectangular shape, it is unnecessary to attach separate components such as a reinforcing plate to reinforce the yoke 10 to the yoke 10, for example. Therefore, the yoke 10 can be prevented from decreasing in strength, which is caused by peeling off of the adhesive for bonding the separate components, such as the reinforcing plate, to the yoke 10. With the yoke 10 maintained in strength, the yoke 10 can be prevented from being deformed comparatively greatly by the reaction force transferred from the magnet 50. Therefore, control characteristics can be improved of displacing the lens holder 3 in the objective lens driving apparatus 100. Since it is unnecessary to combine a plurality of components when forming the yoke 10, the manufacturing cost of the objective lens driving apparatus 100 can be reduced with reduction in the number of components.

The magnet 50 is adjacent in the tangential direction to the lens holder 3 of the optical disc via the first focus coil 34, the second focus coil 36, and the tracking coil 35. The yoke 10 is adjacent in the tangential direction to the magnet 50 on the side opposite to the lens holder 3. The yoke 10, the magnet 50, and the lens holder 3 are adjacent to each other in the tangential direction, and a magnetic circuit is formed that generates the electromagnetic force to displace the lens holder 3 in the focusing direction and the tracking direction. Thus, the magnetic circuit can ensure the displacement of the lens holder 3 in the focusing direction and the tracking direction, thereby being able to improve the control characteristics of displacing the lens holder 3 in the objective lens driving apparatus 100.

One end portion 17 and the other end portion 11D of the metal plate forming the yoke 10 are formed along the tracking direction and are opposed to each other in the focusing direction. The end portion 17 and the end portion 11D are bonded to the surface of the magnet 50 opposing the yoke 10. Therefore, the end portion 17 and the end portion 11D of the yoke 10 are fixed to each other via the magnet 50. The yoke 10 is closed in the rectangular shape with the magnet 50. Thus, the yoke 10 can be improved in strength, thereby improving the control characteristics of displacing the lens holder 3 in the objective lens driving apparatus 100. The end portion 17 and the end portion 11D are fixed to each other when the magnet 50 is fixed to the yoke 10. Therefore, it is unnecessary to separate the process of fixing the magnet 50 to the yoke 10 and the process of fixing the end portion 17 and the end portion 11D to each other, thereby being able to reduce the manufacturing process and further reduce the manufacturing cost of the objective lens driving apparatus 100.

The end portion 17 and the end portion 11D oppose the surface on the yoke 10 side of the end portion farther from the optical disc 300 in the magnet 50. With the adhesive flowing into the space 17D, the magnet 50 is fixed to the yoke 10. The adhesive flowing into the space 17D firmly fixes the end portion 17 and the end portion 11D to each other. Thus, the yoke 10 can be further improved in strength, thereby improving the control characteristics of displacing the lens holder 3 in the objective lens driving apparatus 100.

The yoke 10 includes the projecting portions 17A and 17B. The projecting portions 17A and 17B project from the end portion 17 toward the lens holder 3. The projecting portions 17A and 17B are the portions against which the end portion farther from the optical disc 300 of the magnet 50 abuts when the positioning of the magnet 50 is performed with respect to the yoke 10. The positioning of the magnet 50 with respect to the yoke 50 can be performed in a secure manner. With the magnet 50 securely fixed to the yoke 10 so as to cause the end portions 11D and 17 to be fixed to each other, the yoke 10 can be securely improved in strength. Thus, the control characteristics of displacing the lens holder 3 in the objective lens driving apparatus 100 can be improved. Further, the positioning of the magnet 50 with respect to the yoke 10 can be easily performed. Thus, the manufacturing time of the objective lens driving apparatus 100 is reduced, thereby being able to increase the productivity of the objective lens driving apparatus 100.

The yoke 10 includes the first bent portion 11, the second bent portion 14, the third bent portion 13, and the fourth bent portion 12, the fifth bent portion 15, and the sixth bent portion 16. The first bent portion 11 opposes the magnet 50. The second bent portion 14 opposes the first bent portion 11. The third bent portion 13 opposes the optical disc 300 between the first bent portion 11 and the second bent portion 14. The fourth bent portion 12 opposes the third bent portion 13 between the first bent portion 11 and the second bent portion 14. The fifth bent portion 15 extends, toward the optical disc 300, from one end portion 15B in the tracking direction of the fourth bent portion 12. The sixth bent portion 16 extends, toward the optical disc 300, from the other end portion 16B in the tracking direction of the fourth bent portion 12. The fourth bent portion 12, the fifth bent portion 15, and the sixth bent portion 16 are fixed to the housing 8 with the adhesive. Since the yoke 10 is fixed to the housing 80, comparatively large vibration of the yoke 10 as a whole caused by the reaction force can be prevented. Thus, it becomes possible to suppress the comparatively large vibration of the yoke 10 as a whole, thereby improving the control characteristics of displacing the lens holder 3 in the objective lens driving apparatus 100. The actuator 1 includes the suspension wires 41 to 46 and the support body 70D. The suspension wires 41 to 43 and the suspension wires 44 to 46 support, as a pair, the lens holder 3 on both sides thereof in the tracking direction. The suspension wires 41 to 46 extend in the tangential direction. The support body 70D supports the suspension wires 41 to 46. The support body 70D is fixed to the second bent portion 14 on the side opposite to the magnet 50 of the yoke 10 in the tangential direction. The suspension wires 41 to 43 are arranged between the first bent portion 11 to the fourth bent portion 12 and the fifth bent portion 15. The suspension wires 44 to 46 are arranged between the first bent portion 11 to the fourth bent portion 12 and the sixth bent portion 16. Thus, the yoke 10 can be securely fixed to the housing 80 without interfering with the suspension wires 41 to 46. Therefore, it becomes possible to securely suppress the comparatively large vibration of the yoke 10 as a whole, thereby improving the control characteristics of displacing the lens holder 3 in the objective lens driving apparatus 100.

### Second Embodiment

### Objective Lens Driving Apparatus

An objective lens driving apparatus 800 according to a second embodiment of the present invention has a yoke 900 obtained by changing the yoke 10 according to a first embodiment of the present invention. Since the configuration is similar to that of the objective lens driving apparatus 100 excluding the yoke 900, a description thereof is omitted.

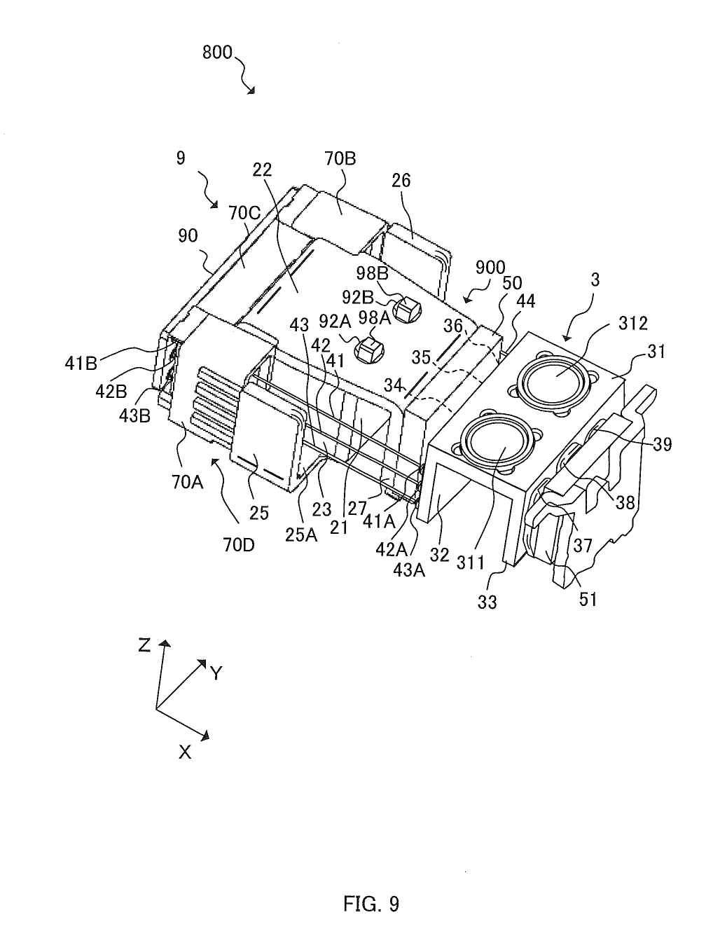

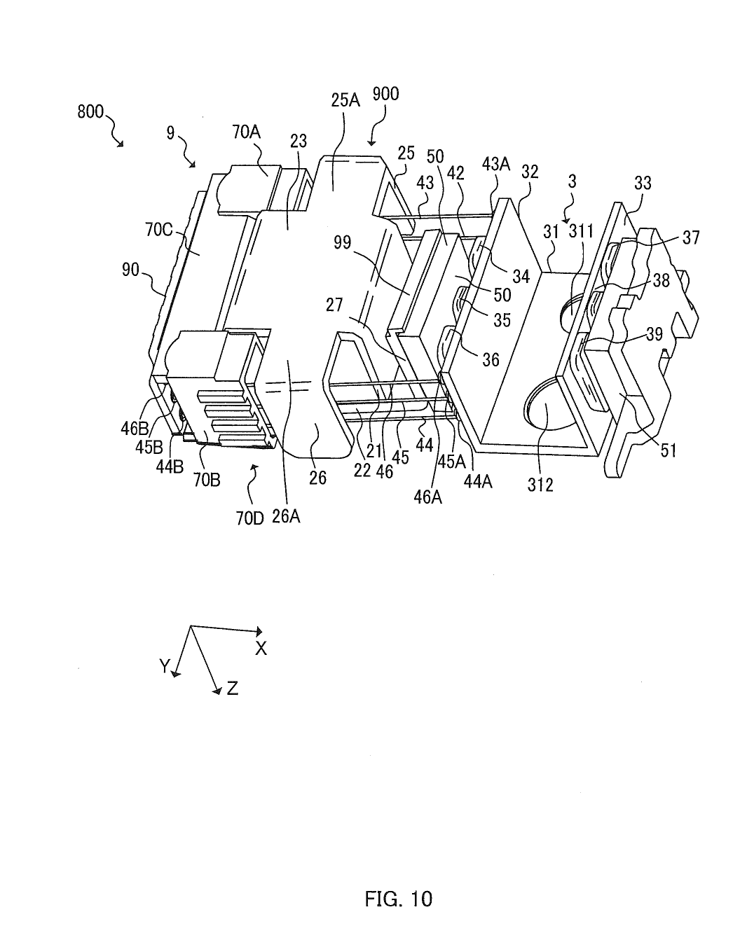

The objective lens driving apparatus in an embodiment of the present invention will hereinafter be described with reference to FIGS. 9 and 10. FIG. 9 is a perspective view of the objective lens driving apparatus when viewed from the side on which the objective lenses are exposed in an embodiment of the present invention. Components similar to those illustrated in FIG. 4 are only given the same reference numerals and the descriptions thereof are omitted. FIG. 10 is a perspective view of the objective lens driving apparatus when viewed from the side to which the foot plates extend in an embodiment of the present invention. Components similar to those illustrated in FIG. 5 is only given the same reference numerals and the descriptions thereof are omitted.

In an embodiment of the present invention, Z axis is an axis along the direction in which the foot plates extends (focusing direction) and the direction going upward is given as +Z direction and the direction going downward is given as −Z direction. X axis is an axis along the direction (tangential direction) in which the yoke 900 are adjacent to the magnet 50 and the direction from the yoke 900 toward the magnet 50 is given as +X direction while the direction from the magnet 50 toward the yoke 900 given as −X direction. Y axis is an axis along the direction (tracking direction) perpendicular to a sixth bent portion 25 and a seventh bent portion 26 and the direction from the sixth bent portion 25 toward the seventh bent portion 26 is given as +Y direction while the direction from the seventh bent portion 26 toward the sixth bent portion 25 is given as −Y direction.

The objective lens driving apparatus 800 includes an actuator 9. The actuator 9 is a device to displace the lens holder 3 in the focusing direction or the tracking direction of the optical disc. The actuator 9 includes the yoke 900.

### Yoke

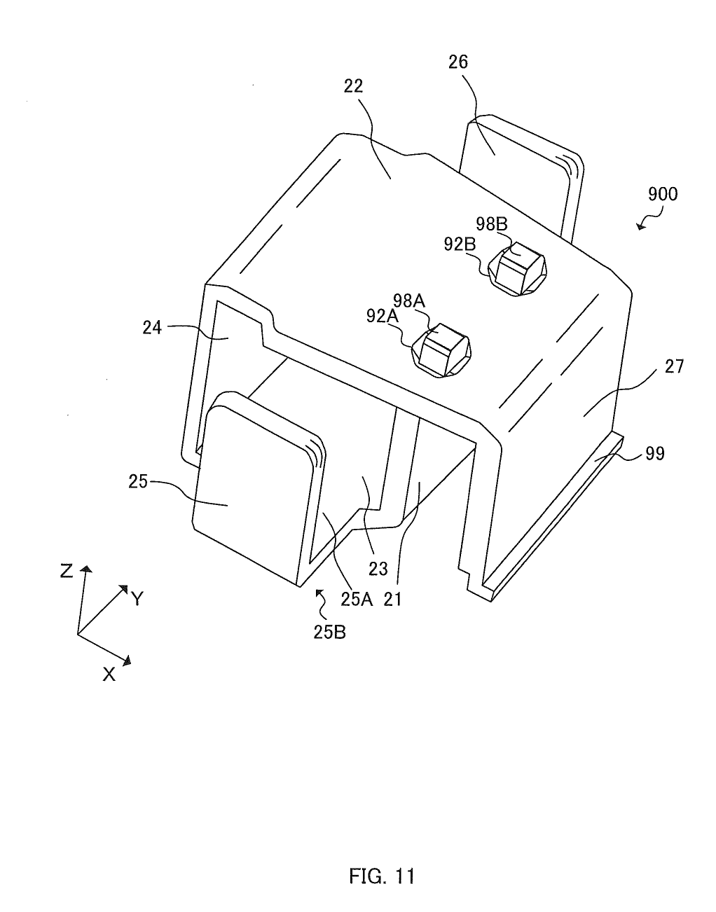

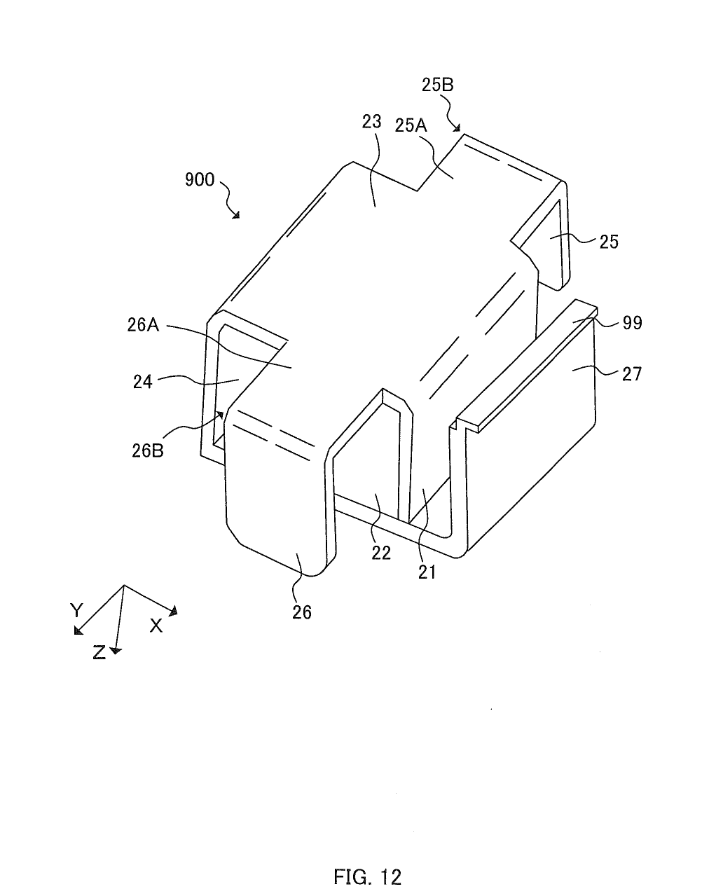

The yoke according to an embodiment of the present invention will hereinafter be described with reference to FIGS. 11 and 12. FIG. 11 is a perspective view of the yoke when viewed from the side to which the sixth bent portion and the seventh bent portion extend in an embodiment of the present invention. FIG. 12 is a perspective view of the yoke when viewed from the side opposite to the side to which the sixth bent portion and the seventh bent portion extend in an embodiment of the present invention.

The yoke 900 is provided between the magnet 50 and the circuit board 90 in the tangential direction. The yoke 900 is formed by bending a sheet of metal plate.

The yoke 900 includes a first bent portion 27, a second bent portion 22, a third bent portion 24, a fourth bent portion 23, a fifth bent portion 21, the sixth bent portion 25, and the seventh bent portion 26. The first bent portion 27, the second bent portion 22, the third bent portion 24, the fourth bent portion 23, and the fifth bent portion 21 are formed by bending a sheet of metal plate into the rectangular shape around the axis of the tracking direction. The sixth bent portion 25 extends from one end portion 25B in the tracking direction of the fourth bent portion 23 toward the optical disc (+Z direction). The seventh bent portion 26 extends from the other end portion 26B in the tracking direction of the fourth bent portion 23 toward the optical disc.

### First to Fifth Bent Portions

The first bent portion 27 is a member to attach the magnet 50 to the yoke 900. The first bent portion 27 is of a substantially rectangular flat plate shape, substantially parallel to the YZ plane formed by the tracking direction and the focusing direction. The first bent portion 27 includes end portions that are along the tracking direction and are opposed to each other in the focusing direction. The first bent portion 27 is formed such that a surface thereof on the magnet 50 side (+X) (hereinafter referred to as “one side” as well) opposes a surface of the magnet 50 on the yoke 900 side (−X) (hereinafter referred to as “the other side” as well). The magnet 50 is fixed, with the adhesive, to the surface of the first bent portion 27 on the one side. The fixing of the magnet 50 to the first bent portion 27 will be described later.

The second bent portion 22 is of a shape formed by being bent at substantially right angle from the end of the first bent portion 27 on the side close to the optical disc (+Z) in the focusing direction toward the side opposite to the magnet 50 (−X) in the tangential direction. The second bent portion 22 is of a substantially rectangular flat plate shape, substantially parallel to the XY plane formed by the tracking direction and the tangential direction. That is to say, the second bent portion 22 is bent so that the surface thereof on the upper side (+Z) opposes the optical disc. The length in the tracking direction of a part of the second bent portion 22 on the side opposite to the magnet 50 is set so as to be comparatively short so that the second bent portion 22 does not interfere with the holding members 70A and 70B (FIG. 9).

Further, for example, two insert holes 92A and 92B are formed along the tracking direction in the second bent portion 22. The insert holes 92A and 92B are through-holes for fixing an end portion of the fifth bent portion 21 on the upper side to the second bent portion 22. The diameter of the insert holes 92A and 92B is set so as to be large enough to allow projections 98A and 98B provided on the fifth bent portion 21 to fit therein, respectively. The fifth bent portion 21 and the projections 98A and 98B will be described later.

The third bent portion 24 is a member to fix the support body 70D to the yoke 900. The third bent portion 24 is of a shape formed by being bent at substantially right angle from the end of the second bent portion 22 on the side opposite to the magnet 50 in the tangential direction toward the side opposite to the optical disc (−Z) in the focusing direction. The third bent portion 24 is of a substantially rectangular flat plate shape, substantially parallel to the first bent portion 27. That is to say, the third bent portion 24 is bent so as to oppose the first bent portion 27. The fixing member 70C is bonded to the surface of the third bent portion 24 on the other side with the adhesive, for example.

The fourth bent portion 23 is a member to fix the yoke 900 to the housing. The fourth bent portion 23 is of a shape formed by being bent at substantially right angle from the end of the third bent portion 24 on the side farther from the optical disc (−Z) in the focusing direction toward the magnet 50 (+X direction). The fourth bent portion 23 is of a flat plate shape, substantially parallel to the second bent portion 22. That is to say, the fourth bent portion 23 is bent so that the surface thereof on the upper side opposes the surface of the second bent portion 22 on the lower side. The length in the tangential direction of the fourth bent portion 23 is set to be shorter than the length in the tangential direction of the second bent portion 22 so that the fifth bent portion 21, which will be described later, is arranged between the first bent portion 27 and the third bent portion 24 in the tangential direction. The fourth bent portion 23 is of a shape having a part thereof 25A on the −Y side and a part thereof 26A on the +Y side in the tracking direction extending away from the center of the fourth bent portion 23 along the tracking direction.

The fifth bent portion 21 is of a shape formed by being bent at substantially right angle from the end of the fourth bent portion 23 on the magnet 50 side in the tangential direction toward the optical disc in the focusing direction. The fifth bent portion 21 is of a substantially rectangular flat plate shape, substantially parallel to the first bent portion 27. That is to say, the fifth bent portion 21 is bent such that the surface of the fifth bent portion 21 on one side opposes the surface of the first bent portion 27 on the other side as well as the surface of the fifth bent portion 21 on the other side opposes the surface of the third bent portion 24 on one side. The length of the fifth bent portion 21 in the focusing direction is set at the same length as that of the third bent portion 24 in the focusing direction so that the end portion of the fifth bent portion 21 on the upper side abuts against the surface of the second bent portion 22 on the lower side, for example.

Further, the projections 98A and 98B projecting upward are formed on the end portion of the fifth bent portion 21 on the upper side. The projections 98A and 98B are used for fixing the end portion of the fifth bent portion 21 on the upper side to the second bent portion 22. The projections 98A and 98B are of such a shape as to fit in the insert holes 92A and 92B, respectively. The length of the projections 98A and 98B is set at such a length that the top of the projections 98A and 98B projecting above the second bent portion 22 through the insert holes 92A and 92B does not get in contact with the optical disc, for example. In order to fix the end portion of the fifth bent portion 21 on the upper side to the second bent portion 22 more firmly, the adhesive is applied continuously to the projections 98A and 98B projecting above the second bent portion 22 through the insert holes 92A and 92B and the surface of the second bent portion 22 on the upper side, for example. The end portion of the fifth bent portion 21 on the upper side and the second bent portion 22 are firmly fixed to each other.

### Sixth and Seventh Bent Portions

The sixth bent portion 25 is a member to fix the yoke 900 to the housing. The sixth bent portion 25 is of a shape formed by being bent from one end portion 25B of a part 25A of the fourth bent portion 23 in the tracking direction toward the optical disc. That is to say, the sixth bent portion 25 extends from the one end portion 25B in the tracking direction of the fourth bent portion 23 toward the optical disc. The sixth bent portion 25 is of a substantially rectangular flat plate shape, substantially parallel to the XZ plane formed by the tangential direction and the focusing direction.

The seventh bent portion 26 is a member to fix the yoke 900 to the housing. The seventh bent portion 26 is of a shape formed by being bent from the other end portion 26B of a part 26A of the fourth bent portion 23 in the tracking direction toward the optical disc. That is to say, the seventh bent portion 26 extends from the other end portion 26B of the fourth bent portion 23 in the tracking direction toward the optical disc. The seventh bent portion 26 is of a substantially rectangular flat plate shape, substantially parallel to the XZ plane formed by the tangential direction and the focusing direction.

### Fixing of Magnet

The fixing of the magnet to the yoke in an embodiment of the present invention will hereinafter be described with reference to FIGS. 10 and 11.

The magnet 50 is fixed to the yoke 900 with the adhesive, for example. The first bent portion 27 of the yoke 900 includes a projecting portion 99. The projecting portion 99 is a portion for performing positioning of the magnet 50 with respect to the yoke 900. The projecting portion 99 is of such a shape as to project from the end portion of the first bent portion 27 on the lower side (−Z) toward one side (+X), for example. The projecting portion 99 is provided in a continuous manner along the tracking direction so that the positioning of the magnet 50 with respect to the yoke 900 can be easily performed. The projecting portion 99 is of such a shape that, when performing positioning of the magnet 50 with respect to the yoke 900, the end portion of the magnet 50 on the side farther from the optical disc (−Z) in the focusing direction abuts the surface of the projecting portion 99 on the upper side (+Z).

The magnet 50 is fixed to the yoke 900 with the adhesive, when the positioning thereof with respect to the yoke 900 is performed, for example.

The positioning of the magnet 50 with respect to the yoke 900 is performed by causing the surfaces opposed to each other of the first bent portion 27 and the magnet 50 to abut as well as causing the surface of the magnet 50 on the lower side to abut the surface of the projecting portion 99 on the upper side, for example.

The magnet 50 is fixed to the yoke 900 by performing the positioning of the magnet 50 with respect to the yoke 900, in a state where the adhesive is applied in advance on the surface of the first bent portion 27 on the one side and the surface of the projecting portion 99 on the upper side, for example. The adhesive may be applied in advance on the surface of the magnet 50 opposing the first bent portion 27 and the surface of the magnet 50 opposing the projecting portion 99, for example. The adhesive may be applied in advance on the surface of the magnet 50 opposing the first bent portion 27, the surface of the magnet 50 opposing the projecting portion 99, the surface of the first bent portion 27 on one side, and the projecting portion 99, for example.

As described above, the yoke 900 includes the first bent portion 27, the second bent portion 22, the third bent portion 24, the fourth bent portion 23, and the fifth bent portion 21. The first bent portion 27 opposes the magnet 50. The second bent portion 22 is bent from the first bent portion 27 to oppose the optical disc. The second bent portion 22 has the insert holes 92A and 92B. The third bent portion 24 is bent from the second bent portion 22 to oppose the first bent portion 27. The fourth bent portion 23 is bent from the third bent portion 24 to oppose the second bent portion 22. The fifth bent portion 21 is bent from the fourth bent portion 23 to oppose both of the first bent portion 27 and the third bent portion 24. The fifth bent portion 21 has the projections 98A sand 98B to fit in the insert holes 92A and 92B. With the projections 98A and 98B fitting in the insert holes 92A and 92B, the second bent portion 22 and the fifth bent portion 21 are fixed to each other. With the second bent portion 22 and the fifth bent portion 21 fixed to each other, the yoke 900 is closed in the rectangular shape. Thus, the yoke 900 is improved in strength, thereby being able to improve the control characteristics of displacing the lens holder 3 in the objective lens driving apparatus 800.

The projections 98A and 98B are bonded to the second bent portion 22 with the adhesive, after fitting in the insert holes 92A and 92B. Thus, the second bent portion 22 and the fifth bent portion 21 are fixed to each other more firmly. Therefore, the yoke 900 is improved in strength, thereby being able to improve the control characteristics of displacing the lens holder 3 in the objective lens driving apparatus 800.

The yoke 900 includes the projecting portion 99. The projecting portion 99 projects from the end portion on the side farther from the optical disc of the first bent portion 27 toward the lens holder. The projecting portion 99 is a portion against which the end portion of the magnet 50 on the side farther from the optical disc abuts when the positioning of the magnet 50 with respect to the yoke 900 is performed. The positioning of the magnet 50 with respect to the yoke 900 can be easily performed. Thus, the manufacturing time of the objective lens driving apparatus 800 is reduced, thereby being able to increase the productivity of the objective lens driving apparatus 800.

The yoke 900 includes the sixth bent portion 25 and the seventh bent portion 26. The sixth bent portion 25 extends from one end portion 25B of the fourth bent portion 23 in the tracking direction toward the optical disc. The seventh bent portion 26 extends from the other end portion 26B of the fourth bent portion 23 in the tracking direction toward the optical disc. The fourth bent portion 23, the sixth bent portion 25, and the seventh bent portion 26 are fixed to the housing with the adhesive. The yoke 900 is fixed to the housing, thereby being able to prevent comparatively large vibration of the yoke 900 as a whole caused by the reaction force. Thus, the comparatively large vibration of the yoke 900 as a whole is suppressed, thereby being able to improve the control characteristics of displacing the lens holder 3 in the objective lens driving apparatus 800.

The actuator 9 includes the suspension wires 41 to 46 and the support body 70D. The suspension wires 41 to 43 and the suspension wires 44 to 46 support, as a pair, both sides of the lens holder 3 in the tracking direction. The suspension wires 41 to 46 extend in the tangential direction. The support body 70D supports the suspension wires 41 to 46. The support body 70D is fixed to the third bent portion 24 on the side opposite to the magnet 50 of the yoke 900 in the tangential direction. The suspension wires 41 to 43 are arranged between the first bent portion 27 to the fifth bent portion 21 and the sixth bent portion 25. The suspension wires 44 to 46 are arranged between the first bent portion 27 to the fifth bent portion 21 and the seventh bent portion 26. Thus, the yoke 900 can be securely fixed to the housing without interfering with the suspension wires 41 to 46. Therefore, the vibration of the yoke 900 as a whole is securely suppressed, thereby being able to improve the control characteristics of displacing the lens holder 3 in the objective lens driving apparatus 800.

### Third Embodiment

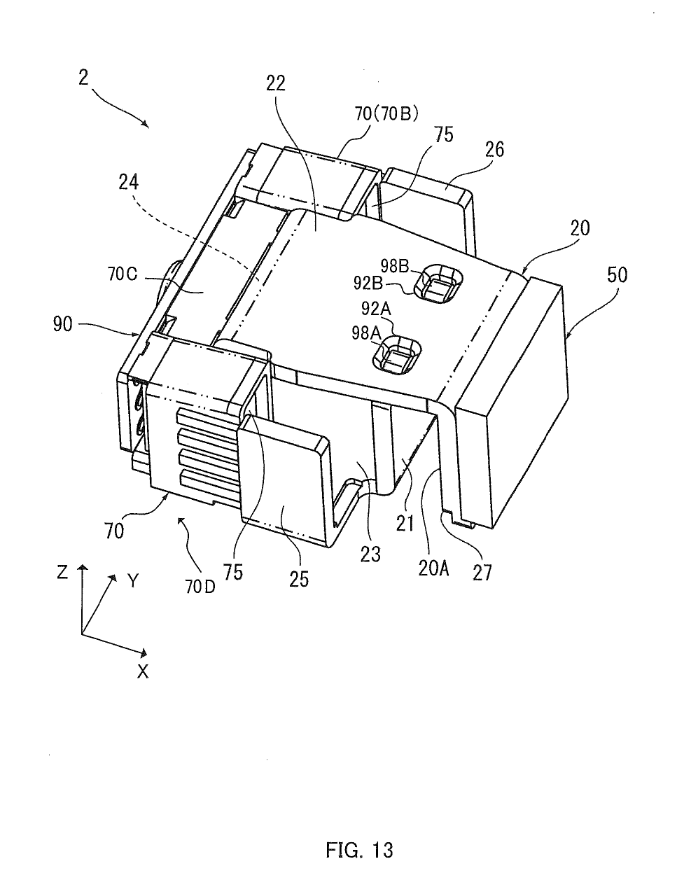

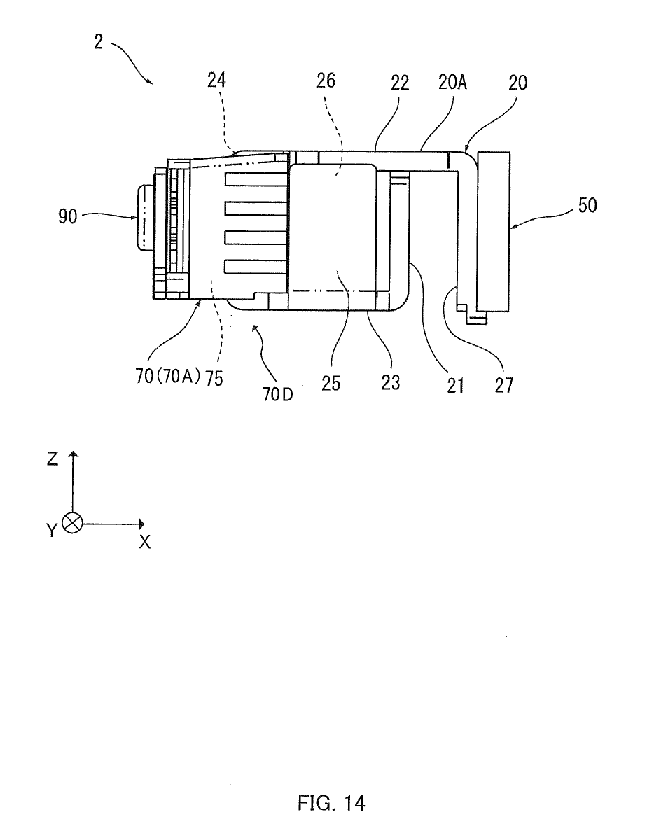

FIGS. 13 and 14 illustrate a driving apparatus frame, a driving apparatus, and a pickup unit according to a third embodiment of the present invention.

FIG. 13 is a perspective view illustrating a part of the objective lens driving apparatus according to an embodiment of the present invention. FIG. 14 is a side view illustrate a part of the objective lens driving apparatus according to an embodiment of the present invention.

In place of the drive apparatus frame 10 illustrated in FIGS. 1 and 2, a driving apparatus frame 20 is provided in the driving apparatus, as illustrated in FIGS. 13 and 14. There is no change in the driving apparatus 1 or the pickup unit except for the replacement of the driving apparatus frame 10 illustrated in FIGS. 1 and 2 with the driving apparatus frame 20 illustrated in FIGS. 13 and 14. Although the first embodiment and the third embodiment are different in that the driving apparatus frame 10 illustrated in FIGS. 1 and 2 is replaced with the driving apparatus frame 20 illustrated in FIGS. 13 and 14, the first and the third embodiments are assumed to be common in components other than the driving apparatus frames 10 and 20. In the third embodiment, components similar to those illustrated in the first embodiment are given the same reference numerals and the detailed descriptions thereof are omitted for the sake of convenience.

When passing a current through a coil configuring an actuator 2 to drive the coil, a reaction force caused by a magnetic force is generated in the magnet 50. In the case where such a event occurs, if the frame/yoke 20 attached with the magnet 50 has low strength, the reaction force applied to the magnet 50 excites resonance of the frame/yoke 20, which may adversely affect the loop characteristics, etc., of the optical pickup unit, for example. Thus, the frame/yoke 20 is required to be increased in strength as much as possible, and increased in natural resonance frequency. The frame actuator 2 assumed to have a configuration capable of equipping the frame/yoke 20 with the magnet 50 and a support component for supporting a moving part.

This driving apparatus frame 20 is configured as an actuator frame/yoke 20 including a metal frame/yoke main body 20A capable of being equipped with the magnet 50 such as a magnet. The frame/yoke main body 20A is closed in a substantially boxlike shape, when viewed from the side.

The frame/yoke main body 20A configuring the frame/yoke 20 for the actuator 2 is formed in a substantially boxlike shape including seven (a plurality of) bent portions (portions) of the fifth bent portion 21, the second bent portion 22, the fourth bent portion 23, the third bent portion 24, the sixth bent portion 25, the seventh bent portion 26, and the first bent portion 27.

A metal material is used to perform and punching processing, bending processing, etc., for one sheet of the metal material, thereby forming the frame/yoke main body 20A. When the frame/yoke main body 20A is closed in the substantially boxlike shape when viewed from the side, the fifth bent portion 21 and the second bent portion 22 configuring the frame/yoke main body 20A are undetachably joined by crimping.

The one is also usable that is formed by undetachably joining the fifth bent portion 21 and the second bent portion 22 configuring the frame/yoke main body 20A with the adhesive, which is used in attaching the magnet 50 to the frame/yoke main body 20A, substantially simultaneously with the bonding process of the magnet 50 when the frame/yoke main body 20A is closed in the substantially boxlike shape when viewed from the side. The one is further usable that is formed by combined process of the bonding and the crimping.

This objective lens driving apparatus 1 is configured as the actuator 2 including at least the actuator frame/yoke 20 and the magnet 50 attached to the actuator frame/yoke 20.

This pickup unit is configured as the optical pickup unit capable of emitting the laser beam, which includes: at least the actuator 2 having the actuator frame/yoke 20 and the magnet 50 attached to the actuator frame/yoke 20; and the objective lens to be driven by the actuator 2 substantially along at least one direction of the up-and-down movement, the right-and-left movement, and the rotational movement, for example.

With the frame/yoke main body 20A configured as a structure closed in substantially boxlike shape when viewed from the side, the strength of the frame/yoke main body 20A can be increased without separate components such as a cover being attached thereto. The effect of reduction in the number of components and man-hours can also be expected.

### Yoke

The yoke according to an embodiment of the present invention will hereinafter be described with reference to FIGS. 13 and 14.

While, in the second embodiment of the present invention, the configuration has been described of fixing the projections 98A and 98B, projecting above the second bent portion 22 through the insert holes 92A and 92B, to the second bent portion 22 with the adhesive, it is not limited thereto. For example, the projections 98A and 98B may be crimped (FIG. 13) so as not to be detached from the second bent portion 22. For example, the projections 98A and 98B, after fitting in the insert holes 92A and 92B, are crimped so that these projections are not detached from the second bent portion 22. In this case, the second bent portion 22 and the fifth bent portion 21 can be more firmly fixed to each other. Further, since the adhesive, for example, is not used in fixing the projections 98A and 98B to the second bent portion 22, the reduction in the strength of the yoke 20 can be prevented which is caused by the peeling-off of the adhesive for fixing the projections 98A and 98B to the second bent portion 22. Thus, the control characteristics of displacing the lens holder in the objective lens driving apparatus including the yoke 20 can be improved.

The first to the third embodiments are simply for facilitating the understanding of the present invention and are not in any way to be construed as limiting the present invention. The present invention may variously be changed or altered without departing from its spirit and encompass equivalents thereof.

In the first embodiment of the present invention, the configuration has been described of fixing the magnet 50 to the yoke 10 with the adhesive after performing the positioning of the magnet 50 with respect to the yoke 10, but it is not limited thereto. For example, the configuration may be such that the adhesive is applied in advance to the surface opposing the magnet 50 of the first bent portion 11 and the opposed surface 17, and the magnet 50 is fixed to the yoke 10 when performing the positioning of the magnet 50 with respect to the yoke 10. In this case, the magnet 50 can be securely fixed to the yoke 10 without flowing the adhesive into the space 17D or causing the adhesive to penetrate into the space between the magnet 50 and the first bent portion 11.

In the first embodiment, the configuration has been described of bonding, with the adhesive, the fourth bent portion 12, the fifth bent portion 15, and the sixth bent portion 16 to the bottom and the side walls 85D and 86D of the hollow 80C in the housing 80, but it is not limited thereto. For example, the housing in which the objective lens driving apparatus 100 is housed may be formed with fixing plates opposing the fifth bent portion 15 and the sixth bent portion 16, and the fourth bent portion 12, the fifth bent portion 15, and the sixth bent portion 16 may be fixed, with the adhesive, to the surface of the housing on which the yoke 10 is placed, the fixing plate opposing the fifth bent portion 15, and the fixing plate opposing the sixth bent portion 16.

In the driving apparatus frames 10 and 20 including the frame main bodies 10A and 20A capable of being equipped with a magnetic member (magnet 50) according to the first to the third embodiments of the present invention, the frame main bodies 10A and 20A are such of a shape as to be closed in the substantially boxlike shape.

In the driving apparatus frames 10 and 20 according to the first to the third embodiments of the present invention, when the frame main bodies 10A and 20A are closed in the substantially boxlike shape, one portion (first bent portion 11, fifth bent portion 21) and the other portion (fourth bent portion 12, second bent portion 22) configuring the frame main bodies 10A and 20A are joined with the adhesive which is used in attaching the magnetic member (magnet) to the frame main bodies 10A and 20A.

In the driving apparatus frames 10 and 20 according to the first to the third embodiments of the present invention, when the frame main bodies 10A and 20A are closed in the substantially boxlike shape, one portion (first bent portion 11, fifth bent portion 21) and the other portion (fourth bent portion 12, second bent portion 22) configuring the frame main bodies 10A and 20A are crimped.

The driving apparatus (actuator 1 or 2) according to the first to the third embodiments of the present invention includes at least the driving apparatus frame 10 or 20 and the magnetic member (magnet 50) attached to the driving apparatus frame 10 or 20.

The pickup unit (optical pickup unit 8) according to the first to the third embodiments of the present invention includes at least the driving apparatus (actuator 1 or 2) including the driving apparatus frame 10 or 20 and the magnetic member (magnet 50) attached to the driving apparatus 10 or 20 and the lenses (first objective lens 311 and the second objective lens 312) to be driven by the driving apparatus.

What is claimed is:

1. An objective lens driving apparatus comprising:
an objective lens opposing a signal recording surface of an optical disc;
a lens holder configured to hold the objective lens; and
an actuator configured to displace the lens holder in a focusing direction or a tracking direction of the optical disc,
the actuator including a coil attached to the lens holder, a magnet configured to generate a magnetic field effectively acting on the coil, and a yoke having the magnet fixed thereto,
the yoke formed by bending a sheet of metal plate into a rectangular shape around an axis in the tracking direction, and
the magnet fixed to the yoke with an adhesive.

2. The objective lens driving apparatus of claim 1, wherein
the magnet is adjacent to the lens holder via the coil in a tangential direction of the optical disc, and wherein
the yoke is adjacent to the magnet on a side opposite to the lens holder in the tangential direction.

3. The objective lens driving apparatus of claim 2, wherein
one end portion and an other end portion of the sheet of metal plate forming the yoke are formed along the tracking direction to oppose each other in the focusing direction and to oppose a first bonding surface of the magnet fixed to the yoke.

4. The objective lens driving apparatus of claim 3, wherein
the one end portion and the other end portion oppose a second bonding surface of an end portion of the magnet on a side farther from the optical disc, and wherein
the magnet is fixed to the yoke with the adhesive flowing into a bonding portion between the yoke and the second bonding surface.

5. The objective lens driving apparatus of claim 4, wherein
the yoke includes a projecting portion projecting, toward the lens holder, from an end of the one end portion on a side farther from the optical disc toward the lens holder, and wherein
the projecting portion is a portion against which the end portion of the magnet on the side farther from the optical disc abuts when positioning of the magnet is performed with respect to the yoke.

6. The objective lens driving apparatus of claim 3, wherein
the yoke includes:
a first bent portion opposing the magnet;
a second bent portion opposing the first bent portion;
a third bent portion opposing the optical disc between the first bent portion and the second bent portion;
a fourth bent portion opposing the third bent portion between the first bent portion and the second bent portion;
a fifth bent portion extending from one end portion of the fourth bent portion in the tracking direction toward the optical disc; and
a six bent portion extending from an other end portion of the fourth bent portion in the tracking direction toward the optical disc, and wherein
the fourth to the sixth bent portions are fixed, with the adhesive, to a housing having the objective lens driving apparatus placed therein.

7. The objective lens driving apparatus of claim 6, wherein
the actuator includes:
one pair of suspension wires configured to support both sides of the lens holder in the tracking direction, the one pair of suspension wires extending along the tangential direction; and
a support body configured to support the one pair of the suspension wires and to be fixed to the second bent portion of the yoke on a side opposite to the magnet in the tangential direction, wherein
one suspension wire out of the one pair of the suspension wires is arranged between the first to the fourth bent portions and the fifth bent portion, and wherein
an other suspension wire out of the one pair of the suspension wires is arranged between the first to the fourth bent portions and the sixth bent portion.

8. The objective lens driving apparatus of claim 2, wherein
the yoke includes:
a first bent portion opposing the magnet;
a second bent portion having an insert hole, the second bent portion bent from the first bent portion to oppose the optical disc;
a third bent portion bent from the second bent portion to oppose the first bent portion;
a fourth bent portion bent from the third bent portion to oppose the second bent portion; and
a fifth bent portion having a projection to fit in the insert hole, the fifth bent portion bent from the fourth bent portion to oppose both of the first bent portion and the third bent portion in between the first bent portion and the third bent portion.

9. The objective lens driving apparatus of claim 8, wherein
the projection, after fitting in the insert hole, is bonded to the second bent portion with the adhesive.

10. The objective lens driving apparatus of claim 8, wherein
the projection, after fitting in the insert hole, is crimped so as not to be detached from the second bent portion.

11. The objective lens driving apparatus of claim 8, wherein
the yoke has a projecting portion projecting, toward the lens holder, from an end portion of the first bent portion on a side farther from the optical disc, and wherein
the projecting portion is a portion against which an end portion of the magnet on a side farther from the optical disc abuts when positioning of the magnet is performed with respect to the yoke.

12. The objective lens driving apparatus of claim 8, wherein
the yoke includes:
a sixth bent portion extending from one end portion of the fourth bent portion in the tracking direction toward the optical disc; and
a seventh bent portion extending from an other end portion of the fourth bent portion in the tracking direction toward the optical disc, and wherein
the fourth bent portion, the sixth bent portion, and the seventh bent portion are fixed, with the adhesive, to a housing having the objective lens driving apparatus placed therein.

13. The objective lens driving apparatus of claim 12, wherein
the actuator includes:
one pair of suspension wires configured to support both sides of the lens holder in the tracking direction, the one pair of suspension wires extending along the tangential direction; and
a support body configured to support the one pair of the suspension wires and to be fixed to the third bent portion of the yoke on a side opposite to the magnet in the tangential direction, wherein
one suspension wire out of the one pair of the suspension wires is arranged between the first to the fifth bent portions and the sixth bent portion, and wherein
an other suspension wire out of the one pair of the suspension wires is arranged between the first to the fifth bent portions and the seventh bent portion.
